(19) United States
(12) Patent Application Publication
(10) Pub. No.: US 2025/0008431 A1
(43) Pub. Date: Jan. 2, 2025

(54) METHOD AND APPARATUS FOR POWER SAVING IN WIRELESS COMMUNICATION SYSTEMS

(71) Applicant: FG Innovation Company Limited, Tuen Mun (HK)

(72) Inventors: CHIA-HSIN LAI, Taipei (TW); HSIN-HSI TSAI, Taipei (TW); MEI-JU SHIH, Taipei (TW); HAI-HAN WANG, Taipei (TW)

(21) Appl. No.: 18/697,584

(22) PCT Filed: Sep. 21, 2022
(86) PCT No.: PCT/CN2022/120333

§ 371 Date: Apr. 1, 2024

Related U.S. Application Data
(60) Provisional application No. 63/251,501, filed on Oct. 1, 2021.

(51) Int. Cl. H04W 52/02; H04L 5/00

(52) U.S. Cl. CPC H04W 52/0225; H04L 5/0053

(57) ABSTRACT

A method performed by a UE for power saving is provided. The method includes receiving DCI that includes an indication related to a procedure of PDCCH monitoring adaptation for one or more first cells. the procedure of PDCCH monitoring adaptation including at least one of: skipping monitoring a PDCCH on the one or more first cells for a particular time period or switching to monitoring an empty SSSG that does not comprise any search space set. The method further includes performing PDCCH monitoring on one or more second cells during a retransmission period, regardless of whether the retransmission period overlaps the particular time period in time domain. A UE using the same is also provided.

### CROSS-REFERENCE TO RELATED APPLICATION(S)

The present disclosure is the National Stage of International Patent Application Serial No. PCT/CN2022/120333, filed on Sep. 21, 2022, which claims the benefit of and priority to U.S. Provisional Patent Application Ser. No. 63/251,501, filed on Oct. 1, 2021, the contents of all of which are hereby incorporated herein fully by reference for all purposes.

### FIELD

The present disclosure generally relates to wireless communication and, more particularly, to methods and apparatuses for power saving in wireless communication systems.

### BACKGROUND

At least some of the acronyms in the present application are defined as follows and, unless otherwise specified, the acronyms have the following meanings:

| Acronym | Full name |
|---|---|
| 3GPP | 3rd Generation Partnership Project |
| 5G | 5th Generation |
| 5GC | 5G Core |
| AS | Access Stratum |
| BA | Bandwidth Adaptation |
| BS | Base Station |
| BFR | Beam Failure Recovery |
| BSR | Buffer Status Report |
| BWP | Bandwidth Part |
| CA | Carrier Aggregation |
| CCCH | Common Control Channel |
| CE | Control Element |
| CH | Channel |
| CN | Core Network |
| CORESET | Control Resource Set |
| CRC | Cyclic Redundancy Check |
| CSI | Channel State Information |
| CSS | Common Search Space |
| DC | Dual Connectivity |
| DCI | Downlink Control Information |
| DCP | DCI with CRC scrambled by PS-RNTI |
| DL | Downlink |
| DRB | Data Radio Bearer |
| DRX | Discontinuous Reception |
| E-UTRA(N) | Evolved Universal Terrestrial Radio Access (Network) |
| EPC | Evolved Packet Core |
| FR | Frequency Range |
| HARQ | Hybrid Automatic Repeat reQuest |
| ID | Identifier/Identity/Identification |
| IE | Information Element |
| LAN | Local Area Network |
| LBT | Listen Before Talk |
| LSB | Least Significant Bit |
| LTE | Long Term Evolution |
| MAC | Medium Access Control |
| MAC CE | MAC Control Element |
| MCG | Master Cell Group |
| MIB | Master Information Block |
| MN | Master Node |
| MSB | Most Significant Bit |
| MSG | Message |
| NAS | Non-Access Stratum |
| NE-DC | NR - E-UTRA Dual Connectivity |
| NR | New Radio |
| NR-U | NR Unlicensed |
| NW | Network |
| PCell | Primary Cell |
| PDCCH | Physical Downlink Control Channel |
| PDCP | Packet Data Convergence Protocol |
| PDSCH | Physical Downlink Shared Channel |
| PDU | Protocol Data Unit |
| PHR | Power Headroom Report |
| PHY | Physical (layer) |
| PLMN | Public Land Mobile Network |
| PRACH | Physical Random Access Channel |
| PS-RNTI | Power Saving RNTI |
| PSCell | Primary SCG Cell/Primary Secondary Cell |
| PUCCH | Physical Uplink Control Channel |
| PUSCH | Physical Uplink Shared Channel |
| QoS | Quality of Service |
| RA | Random Access |
| RAN | Radio Access Network |
| RAR | Random Access Response |
| RAT | Radio Access Technology |
| Rel | Release |
| RF | Radio Frequency |
| RLC | Radio Link Control |
| RNTI | Radio Network Temporary Identifier |
| RRC | Radio Resource Control |
| RS | Reference Signal |
| SCell | Secondary Cell |
| SCG | Secondary Cell Group |
| SCS | Subcarrier Spacing |
| SDAP | Service Data Adaptation Protocol |
| SI | System Information |
| SIB | System Information Block |
| SL | Sidelink |
| SN | Secondary Node |
| SPS | Semi-Persistent Scheduling |
| SRB | Signaling Radio Bearer |
| SS | Search Space |
| SSSG | Search Space Set Group |
| SR | Scheduling Request |
| TRP | Transmission/Reception Point |
| TS | Technical Specification |
| UE | User Equipment |
| UL | Uplink |
| USS | UE-specific Search Space |
| V2X | Vehicle-to-Everything |

With the tremendous growth in the number of connected devices and the rapid increase in user/network traffic volume, various efforts have been made to improve different aspects of wireless communication for the next-generation wireless communication systems, such as the fifth-generation (5G) New Radio (NR) system, by improving data rate, latency, reliability, and mobility.

The 5G NR system is designed to provide flexibility and configurability to optimize network services and types, thus accommodating various use cases, such as enhanced Mobile Broadband (eMBB), massive Machine-Type Communication (mMTC), and Ultra-Reliable and Low-Latency Communication (URLLC).

However, as the demand for radio access continues to increase, there is a need for further improvements in wireless communications in the next-generation wireless communication systems.

### SUMMARY

The present disclosure is directed to methods and apparatuses for power saving in wireless communication systems.

According to a first aspect of the present disclosure, a method performed by a User Equipment (UE) for power saving is provided. The method includes receiving Downlink Control Information (DCI) that includes an indication related to a procedure of a Physical Downlink Control Channel (PDCCH) monitoring adaptation for one or more first cells, the procedure of the PDCCH monitoring adaptation including at least one of: skipping monitoring a PDCCH on the one or more first cells for a particular time period, or switching to monitoring an empty Search Space Set Group (SSSG) that does not include any search space set; and performing a PDCCH monitoring on one or more second cells during a retransmission period, regardless of whether the retransmission period overlaps the particular time period in time domain.

In some implementations of the first aspect of the present disclosure, performing the PDCCH monitoring includes terminating the procedure of the PDCCH monitoring adaptation.

In some implementations of the first aspect of the present disclosure, the retransmission period is a time period in which a Discontinuous Reception (DRX) retransmission timer is running.

In some implementations of the first aspect of the present disclosure, the DRX retransmission timer is determined by a parameter denoted by drx-RetransmissionTimerDL.

In some implementations of the first aspect of the present disclosure, the DRX retransmission timer is determined by a parameter denoted by drx-RetransmissionTimerUL.

In some implementations of the first aspect of the present disclosure, the retransmission period overlaps at least a part of the particular time period in the time domain.

In some implementations of the first aspect of the present disclosure, the one or more second cells include at least one of a Primary Cell (PCell), a Special Cell (SpCell), or a Secondary Cell (SCell).

In some implementations of the first aspect of the present disclosure, the DCI indicates the one or more first cells.

In some implementations of the first aspect of the present disclosure, the one or more second cells include at least one of the one or more first cells indicated by the DCI.

In some implementations of the first aspect of the present disclosure, the one or more second cells include a cell through which the UE receives the DCI.

According to a second aspect of the present disclosure, a User Equipment (UE) for power saving is provided. The UE includes at least one processor and at least one memory coupled to the at least one processor. The at least one memory stores a set of computer-executable instructions that, when executed by the at least one processor, cause the UE to: receive Downlink Control Information (DCI) that includes an indication related to a procedure of a Physical Downlink Control Channel (PDCCH) monitoring adaptation for one or more first cells, the procedure of the PDCCH monitoring adaptation including at least one of: skipping monitoring a PDCCH on the one or more first cells for a particular time period, or switching to monitoring an empty Search Space Set Group (SSSG) that does not include any search space set; and perform a PDCCH monitoring on one or more second cells during a retransmission period, regardless of whether the retransmission period overlaps the particular time period in time domain.

In some implementations of the second aspect of the present disclosure, performing the PDCCH monitoring includes terminating the procedure of the PDCCH monitoring adaptation.

In some implementations of the second aspect of the present disclosure, the retransmission period is a time period in which a Discontinuous Reception (DRX) retransmission timer is running.

In some implementations of the second aspect of the present disclosure, the DRX retransmission timer is determined by a parameter denoted by drx-RetransmissionTimerDL.

In some implementations of the second aspect of the present disclosure, the DRX retransmission timer is determined by a parameter denoted by drx-RetransmissionTimerUL.

In some implementations of the second aspect of the present disclosure, the retransmission period overlaps at least a part of the particular time period in the time domain.

In some implementations of the second aspect of the present disclosure, the one or more second cells include at least one of a Primary Cell (PCell), a Special Cell (SpCell), or a Secondary Cell (SCell).

In some implementations of the second aspect of the present disclosure, the DCI indicates the one or more first cells.

In some implementations of the second aspect of the present disclosure, the one or more second cells include at least one of the one or more first cells indicated by the DCI.

In some implementations of the second aspect of the present disclosure, the one or more second cells include a cell through which the UE receives the DCI.

### BRIEF DESCRIPTION OF THE DRAWINGS

Aspects of the example disclosure are best understood from the following detailed description when read with the accompanying figures. Various features are not drawn to scale. Dimensions of various features may be arbitrarily increased or reduced for clarity of discussion.

FIG. 1 is a timing diagram illustrating a DRX operation, according to an example implementation of the present disclosure.

FIG. 2 is a state transition diagram illustrating an explicit SS switching mechanism for a UE, according to an example implementation of the present disclosure.

FIG. 3 is a state transition diagram illustrating an implicit SS switching mechanism for a UE, according to an example implementation of the present disclosure.

FIG. 4 is a schematic diagram illustrating the identification of PDCCH monitoring occasions, according to an example implementation of the present disclosure.

FIG. 5 is a schematic diagram illustrating a scheme of skipping the PDCCH monitoring, according to an example implementation of the present disclosure.

FIG. 6 is a schematic diagram illustrating a DCP mechanism, according to an example implementation of the present disclosure.

FIG. 7 is a timing diagram illustrating that the UE performs the PDCCH monitoring in an SpCell at least during a retransmission period, according to an example implementation of the present disclosure.

FIG. 8 is a timing diagram illustrating that the UE performs the PDCCH monitoring at least during a retransmission period in the SpCell and all serving cell(s) indicated by the DCI for the PDCCH monitoring adaptation, according to an example implementation of the present disclosure.

FIG. 9 is a schematic diagram illustrating a retransmission period, according to an example implementation of the present disclosure.

FIG. 10 is a flowchart of a method performed by a UE for power saving, according to an example implementation of the present disclosure.

FIG. 11 is a block diagram illustrating a node for wireless communication, according to an example implementation of the present disclosure.

### DETAILED DESCRIPTION

The following contains specific information related to implementations of the present disclosure. The drawings and their accompanying detailed description are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may differ in other respects and shall not be narrowly confined to what is illustrated in the drawings.

The phrases “in some implementations” or “In some implementations” may each refer to one or more of the same or different implementations. The term “coupled” is defined as connected, whether directly or indirectly via intervening components, and is not necessarily limited to physical connections. The term “comprising” means “including, but not necessarily limited to” and specifically indicates open-ended inclusion or membership in the disclosed combination, group, series, or equivalent. The expression “at least one of A, B and C,” “at least one of the following: A, B and C,” or “at least one of A, B or C,” means “only A, or only B, or only C, or any combination of A, B and C.”

The terms “system” and “network” may be used interchangeably. The term “and/or” is only an association relationship for disclosing associated objects and represents that three relationships may exist. For example, A and/or B may indicate that A exists alone, A and B exist at the same time, or B exists alone. “A and/or B and/or C” may represent that at least one of A, B, and C exists. The character “/” generally represents that the associated objects are in an “or” relationship.

For the purposes of explanation and non-limitation, specific details, such as functional entities, techniques, protocols, standards, and the like, are set forth for providing an understanding of the disclosed technology. In other examples, detailed disclosures of well-known methods, technologies, systems, architectures, and the like are omitted so as not to obscure the present disclosure with unnecessary details.

Persons skilled in the art will immediately recognize that any disclosed network function(s) or algorithm(s) may be implemented by hardware, software, or a combination of software and hardware. Disclosed functions may correspond to modules which may be software, hardware, firmware, or any combination thereof.

A software implementation may include computer-executable instructions stored on a computer-readable medium, such as memory or other type of storage devices. One or more microprocessors or general-purpose computers with communication processing capability may be programmed with corresponding computer-executable instructions and perform the disclosed network function(s) or algorithm(s).

The microprocessors or general-purpose computers may include Application-Specific Integrated Circuits (ASICs), programmable logic arrays, and/or one or more Digital Signal Processors (DSPs). Although some of the disclosed implementations are oriented to software installed and executing on computer hardware, alternative implementations implemented as firmware, as hardware, or as a combination of hardware and software are well within the scope of the present disclosure. The computer-readable medium may include, but is not limited to, Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN), may typically include at least one base station (BS), at least one UE, and one or more optional network elements that provide connection within a network. The UE may communicate with the network, such as a Core Network (CN), an Evolved Packet Core (EPC) network, an Evolved Universal Terrestrial RAN (E-UTRAN), a Next-Generation Core (NGC), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE may be configured to receive and transmit signals over an air interface to one or more cells in a RAN.

The BS may be configured to provide communication services according to at least a Radio Access Technology (RAT), such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic Wideband-Code Division Multiple Access (W-CDMA), High-Speed Packet Access (HSPA), LTE, LTE-A, evolved/enhanced LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, a next-generation eNB (ng-eNB) in an Evolved Universal Terrestrial Radio Access (E-UTRA) BS in connection with 5GC, a next-generation Node B (gNB) in the 5G-RAN (or in the 5G Access Network (5G-AN)), or any other apparatus capable of controlling radio communication and managing radio resources within a cell. The BS may serve one or more UEs via a radio interface.

The BS may provide radio coverage to a specific geographical area using a plurality of cells included in the RAN. The BS may support the operations of the cells. Each cell may be operable to provide services to at least one UE within its radio coverage.

Each cell (often referred to as a serving cell) may provide services to serve one or more UEs within its radio coverage such that each cell schedules the downlink (DL) and optionally uplink (UL) resources to at least one UE within its radio coverage for DL and optionally UL packet transmissions. The BS may communicate with one or more UEs in the radio communication system via the plurality of cells.

A cell may allocate Sidelink (SL) resources for supporting Proximity Service (ProSe), LTE SL services, LTE/NR sidelink communication services, LTE/NR sidelink discovery services, and/or LTE/NR Vehicle-to-Everything (V2X) services.

The terms, definitions, and abbreviations as given in this document are either imported from existing documentation (European Telecommunications Standards Institute (ETSI), International Telecommunication Union (ITU), or elsewhere) or newly created by 3GPP experts whenever the need for precise vocabulary is identified.

In NR-U, search space set group (SSSG) switching may allow the network (NW) to dynamically switch the search space set by a DCI format 2_0. However, since the DCI format 2_0 is transmitted in the CSS, which is not UE-specific and is used for transmitting a slot format indication, it may be more flexible if a DCI format for SSSG switching is transmitted in the USS in a UE-specific manner and/or transmitted by a specific DCI format, such as a DCI format 0_1, a DCI format 1_1, and a DCI format 2_6, but not limited thereto, which may be tailored for a power saving indication.

In some implementations, a DCI format 2_6 may be used for notifying the power saving information outside the DRX Active Time for one or more UEs. The following information may be transmitted by means of the DCI format 2_6 with CRC scrambled by PS-RNTI:
block number 1, block number 2, . . . , block number N, where the starting position of a block is determined by the parameter ps-PositionDCI-2-6 provided by the higher layers for the UE configured with the block.

If the UE is configured with the higher layer parameter PS-RNTI and a DCI format 2_6, one block may be configured for the UE, by the higher layers, with the following fields defined for the block:
Wake-up indication, which may be 1 bit, and
Dormancy indication, which may be 0 bit if the higher layer parameter Scell-groups-for-dormancy-outside-active-time is not configured; otherwise 1, 2, 3, 4 or 5 bits bitmap may be determined according to the higher layer parameter Scell-groups-for-dormancy-outside-active-time, where each bit corresponds to one of the SCell group(s) configured by the higher layers parameter Scell-groups-for-dormancy-outside-active-time, with MSB to LSB of the bitmap corresponding to the first to the last configured SCell group. The size of a DCI format 2_6 may be indicated by the higher layer parameter sizeDCI2-6.

In some implementations, a DCI format 0_1 may be used for the scheduling of one or multiple PUSCH in one cell, or indicating CG downlink feedback information (CG-DFI) to a UE.

In some implementations, a DCI format 1_1 may be used for the scheduling of PDSCH in one cell.

Examples of some selected terms are provided as follows.

User Equipment (UE): The UE may be referred to as PHY/MAC/RLC/PDCP/SDAP entity. The PHY/MAC/RLC/PDCP/SDAP entity may be referred to as the UE.

Network (NW): The NW may be a network node, a TRP, a cell (e.g., SpCell (Special Cell), PCell, PSCell, and/or SCell), an eNB, a gNB, and/or a base station.

Serving Cell: A PCell, a PSCell, or an SCell. The serving cell may be an activated or a deactivated serving cell.

Special Cell (SpCell): For Dual Connectivity operation, the term Special Cell refers to the PCell of the MCG or the PSCell of the SCG, depending on whether the MAC entity is associated with the MCG or the SCG, respectively. Otherwise, the term Special Cell refers to the PCell. A Special Cell supports PUCCH transmission and contention-based Random Access and is always activated.

### UE Power Saving

The PDCCH monitoring activity of the UE in RRC connected mode may be governed by DRX, BA, DCP, etc.

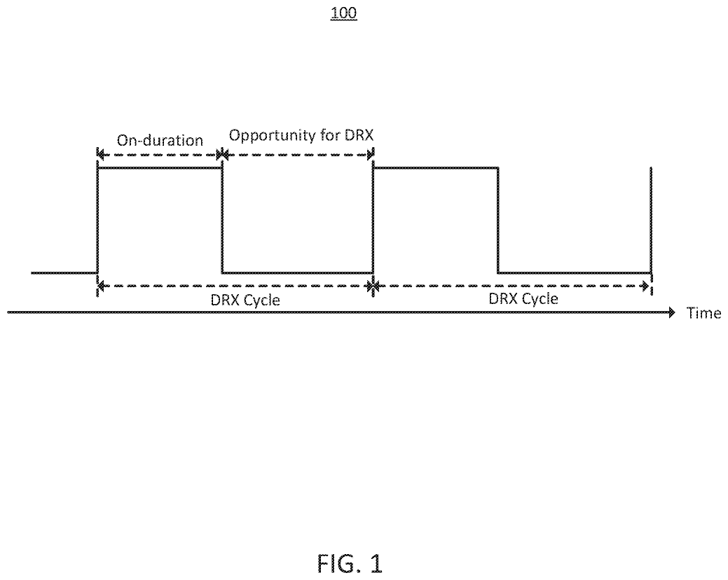

FIG. 1 is a timing diagram 100 illustrating a DRX operation, according to an example implementation of the present disclosure. When DRX is configured, the UE does not have to continuously monitor a PDCCH. DRX may be characterized by the following:

(DRX) on-duration: a duration that the UE waits for, after waking up, to receive PDCCHs. If the UE successfully decodes a PDCCH, the UE stays awake and starts the inactivity timer;

(DRX) inactivity-timer: a duration that the UE waits to successfully decode a PDCCH from the last successful decoding of a PDCCH, failing which it can go back to sleep. The UE shall restart the inactivity timer following a single successful decoding of a PDCCH for a first transmission only (i.e., not for retransmissions);

(DRX) retransmission-timer: a duration until a retransmission can be expected;

(DRX) cycle: specifies the periodic repetition of the on-duration followed by a possible period of inactivity;

(DRX) active time: the total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

When BA is configured, the UE may monitor a PDCCH on an active BWP. The UE does not have to monitor a PDCCH on the entire DL frequency of the cell. The UE may use a BWP inactivity timer (which may be independent of the DRX inactivity-timer described above) to switch the active BWP to the default one. In some implementations, the BWP inactivity timer may be restarted upon a successful PDCCH decoding, and the UE may switch to the default BWP when the BWP inactivity timer expires.

In addition, the UE may be indicated, when configured accordingly, whether it is required to monitor the PDCCH during the next occurrence of the on-duration by a DCP monitored on the active BWP. When the UE does not detect a DCP on the active BWP, the UE may not monitor the PDCCH during the next occurrence of the on-duration, unless the UE is explicitly configured to do so. The UE may only be configured to monitor the DCP when connected mode DRX is configured, and at occasion(s) that have a configured offset before the on-duration. More than one monitoring occasion may be configured before the on-duration. The UE may not monitor the DCP on occasions occurring during the active-time, measurement gaps, or BWP switching, in which case the UE may monitor the PDCCH during the next on-duration. If no DCP is configured in the active BWP, the UE may follow a normal DRX operation. When CA is configured, a DCP may only be configured on the pCell. A DCP may be configured to control the PDCCH monitoring during an on-duration for one or more UEs independently.

In some implementations, power saving for a UE in an RRC_IDLE mode and/or in an RRC_INACTIVE mode may be achieved by having the UE relax neighboring cells' radio resource management (RRM) measurements, for example, when the UE meets one or more criteria. The one or more criteria may include the UE being in low mobility and/or not being located at a cell edge. In some implementations, the UE power saving may be enabled by adapting a DL maximum number of multiple input multiple output (MIMO) layers via BWP switching. In some implementations, power saving may be enabled during an active-time via cross-slot scheduling, which may facilitate the power saving under the assumption that the UE may not be scheduled to receive a PDSCH or may not be triggered to receive an aperiodic CSI (A-CSI) or transmit a PUSCH scheduled by a PDCCH until reaching the minimum scheduling offsets (e.g., offsets K0 and K2). In some implementations, dynamic adaptation of the minimum scheduling offsets K0 and K2 may be controlled by a PDCCH.

### Dynamic Search Space (SS) Adaptation

### Explicit SS Switching

In some implementations, a dynamic SS adaptation may include SS set group (SSSG) switching in which a UE may be configured to switch between two different types of the PDCCH monitoring (e.g., sparse/frequent PDCCH monitoring occasions). The search space set group may be replaced by “search space set” or “search space group” in the present disclosure. The search space set may also be replaced by “search space set group” or “search space group” in the present disclosure. In some implementations, the SSSG switching may be implemented by other mechanisms, such as an explicit indication, an implicit indication, an implicit condition, and/or by a timer.

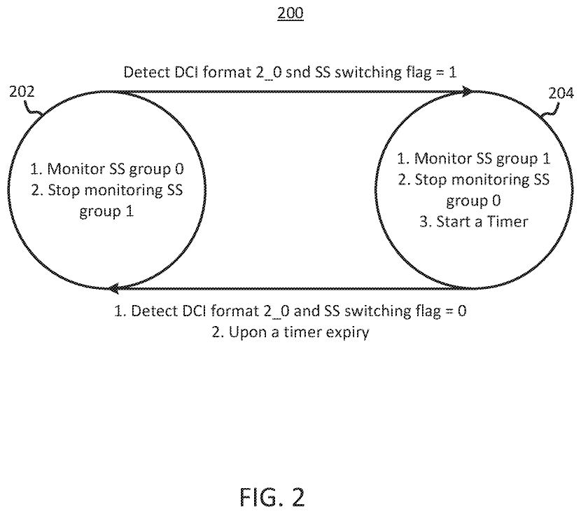

FIG. 2 is a state transition diagram 200 illustrating an explicit SS switching mechanism for a UE, according to an example implementation of the present disclosure. An explicit switching of two SS set groups may be achieved via the detection of a specific (e.g., a DCI format 2_0). The UE may be configured with an RRC parameter searchSpaceSwitchTrigger-r16. Each SearchSpaceSwitchingTrigger object provides a position in a DCI format 2_0 of the bit field indicating a search space switching flag for a serving cell or, if the CellGroupsForSwitching-r16 is configured, a group of serving cells. The bit value zero (0) of the search space switching flag may indicate one SS set group (e.g., SS set group #0) to be monitored, and the bit value one (1) of the search space switching flag may indicate the second SS set group (e.g., SS set group #1) to be monitored.

The RRC parameter searchSpaceSwitchTrigger-r16 may be included in an IE slot format indicator (e.g., SlofFormatIndicator). Table 1 below illustrates the data structure of an example slot format indicator. In some implementations, the IE SlofFormatIndicator may be used to configure monitoring a group-common PDCCH for Slot-Format-Indicators (SFI).

TABLE 1

| | |
|---|---|
| SlotFormatIndicator ::= | SEQUENCE { |
| sfi-RNTI | RNTI-Value, |
| dci-PayloadSize | INTEGER (1..maxSFI-DCI-PayloadSize), |

```
  [...]
  searchSpaceSwitchTriggerToAddModList-r16 SEQUENCE (SIZE(1..4)) OF
SearchSpaceSwitchTrigger-r16 OPTIONAL, -- Need N
  searchSpaceSwitchTriggerToReleaseList-r16 SEQUENCE (SIZE(1..4)) OF ServCellIndex
OPTIONAL, -- Need N
  [...]
SearchSpaceSwitchTrigger-r16 ::= SEQUENCE {
```

| | |
|---|---|
| servingCellId-r16 | ServCellIndex, |
| positionInDCI-r16 | INTEGER(0..maxSFI-DCI-PayloadSize−1) |

}

Table 2 below illustrates a data structure of an example PDCCH configuration. In some implementations, the IE PDCCH-config may be used to determine the PDCCH configuration.

TABLE 2

| PDCCH-Config ::= | SEQUENCE { | |
|---|---|---|
| controlResourceSetToAddModList | SEQUENCE(SIZE (1..3)) OF ControlResourceSet | OPTIONAL, |

-- Need N

| | | |
|---|---|---|
| controlResourceSetToReleaseList | SEQUENCE(SIZE (1..3)) OF ControlResourceSetId | OPTIONAL, |

-- Need N

| | | |
|---|---|---|
| searchSpacesToAddModList | SEQUENCE(SIZE (1..10)) OF SearchSpace | OPTIONAL, |

-- Need N

| | | |
|---|---|---|
| searchSpacesToReleaseList | SEQUENCE(SIZE (1..10)) OF SearchSpaceId | OPTIONAL, |

```
-- Need N
  ...,
  [[
```

| | |
|---|---|
| controlResourceSetToAddModList2-r16 | SEQUENCE (SIZE (1..2)) OF ControlResourceSet |

OPTIONAL, -- Need N

| | |
|---|---|
| controlResourceSetToReleaseList-r16 | SEQUENCE (SIZE (1..5)) OF ControlResourceSetId-r16 |

OPTIONAL, -- Need N

| | |
|---|---|
| searchSpacesToAddModListExt-r16 | SEQUENCE(SIZE (1..10)) OF SearchSpaceExt-r16 |

OPTIONAL, -- Need N

| | | |
|---|---|---|
| uplinkCancellation-r16 | SetupRelease { UplinkCancellation-r16 } | OPTIONAL, -- Need |

M

| | |
|---|---|
| monitoringCapabilityConfig-r16 | ENUMERATED { r15monitoringcapability,r16monitoringcapability } |

OPTIONAL, -- Need M

| | | |
|---|---|---|
| searchSpaceSwitchConfig-r16 | SearchSpaceSwitchConfig-r16 | OPTIONAL - |

- Need R
]]
}

| SearchSpaceSwitchConfig-r16 ::= | SEQUENCE { | |
|---|---|---|
| cellGroupsForSwitchList-r16 | SEQUENCE(SIZE (1..4)) OF CellGroupForSwitch-r16 | OPTIONAL, |

-- Need R

| | | |
|---|---|---|
| searchSpaceSwitchDelay-r16 | INTEGER (10..52) | OPTIONAL -- Need R |

}

| | |
|---|---|
| CellGroupForSwitch-r16 ::= | SEQUENCE(SIZE (1..16)) OF ServCellIndex |

In some implementations, the IE cellGroupsForSwitchList may be used to configure a list of serving cells that are bundled for the search space group switching purpose. A serving cell may belong to only one cell group for a switch (or CellGroupForSwitch). The NW may configure the same list for all the BWPs of the serving cells in the same CellGroupForSwitch.

Table 3 below illustrates an example data structure of a serving cell configuration. In some implementations, the IE ServingCellConfig may be used to determine the serving cell configuration.

TABLE 3

| | |
|---|---|
| ServingCellConfig ::= | SEQUENCE { |

...

| WithinActiveTimeConfig-r16 ::= | SEQUENCE { | |
|---|---|---|
| firstWithinActiveTimeBWP-Id-r16 | BWP-Id | OPTIONAL, -- Need M |
| dormancyGroupWithinActiveTime-r16 | DormancyGroupID-r16 | OPTIONAL -- |

Need R
}

| OutsideActiveTimeConfig-r16 ::= | SEQUENCE { | |
|---|---|---|
| firstOutsideActiveTimeBWP-Id-r16 | BWP-Id | OPTIONAL, -- Need M |
| dormancyGroupOutsideActiveTime-r16 | DormancyGroupID-r16 | OPTIONAL - |

- Need R
}

In some implementations, the IE searchSpaceSwitchTriggerToAddModList may be used to configure a list of SearchSpaceSwitchingTrigger objects. Each SearchSpaceSwitchingTrigger object may provide a position, in the DCI, of the bit field indicating a search space switching flag for a serving cell or, if the IE CellGroupsForSwitching-r16 is configured, a group of serving cells.

In FIG. 2, when the UE is in the state 202, the UE monitors SS set group #0 and stops monitoring SS set group #1. When DCI (e.g., a DCI format 2_0) is detected by the UE and the SSSG switching flag=1, the UE may switch from the state 202 to the state 204.

When the UE is in the state 204, the UE monitors SS set group #1 and stops monitoring SS set group #0. In some implementations, when DCI (e.g., a DCI format 2_0) is detected by the UE and the SSSG switching flag=0, the UE may switch from the state 204 to the state 202. In some implementations, the UE may start a timer in the state 204, and upon expiration of the timer, the UE may switch from the state 204 to the state 202.

### Search Space Set Group (SSSG) Switching

In some implementations, the UE may be provided with a group index for a respective Type3-PDCCH CSS set or USS set by the IE, searchSpaceGroupIdList-r16, for the PDCCH monitoring on a serving cell. If the UE is not provided with the searchSpaceGroupIdList-r16 for a search space set, the following procedures may not be applicable for the PDCCH monitoring, according to the search space set.

If the UE is provided with the searchSpaceSwitchingGroupList-r 16, indicating one or more groups of serving cells, the following procedures may apply to all serving cells within each group; otherwise, the following procedures may apply only to a serving cell for which the UE is provided with the searchSpaceGroupIdList-r16.

When the UE is provided with the searchSpaceGroupIDList-r16, the UE may reset the PDCCH monitoring according to search space sets with group index 0, if provided by searchSpaceGroupIdList-r16.

The UE may be provided, by searchSpaceSwitchingDelay-r16, with a number of symbols P_{switch} where a minimum value of P_{switch} may be provided in Table 4 below for the UE processing capability 1, UE processing capability 2, and SCS configuration μ. The UE processing capability 1 for SCS configuration μ may be applied, unless the UE indicates support for the UE processing capability 2.

TABLE 4
Minimum value of P_{switch} [symbols]

| | Minimum P_{switch} value for | Minimum P_{switch} value for |
|---|---|---|
| | UE processing capability 1 | UE processing capability 2 |
| μ | [symbols] | [symbols] |
| 0 | 25 | 10 |
| 1 | 25 | 12 |
| 2 | 25 | 22 |

The UE may be provided, by searchSpaceSwitching Timer-r16, with a timer value for a serving cell or, if provided, for a set of serving cells. The UE may decrement the timer value by one after each slot based on a reference SCS configuration that is the smallest SCS configuration μ among all the configured DL BWPs in the serving cell, or in the set of serving cells. The UE may maintain the reference SCS configuration during the timer decrement procedure.

If the UE is provided, by the SearchSpaceSwitchTrigger-r16, with a location of a search space set group switching flag field for a serving cell in a DCI format 2_0:
if the UE detects a DCI format 2_0 and a value of the search space set group switching flag field in the DCI format 2_0 is 0, the UE may start monitoring the PDCCH, according to the search space sets with group index 0, and may stop monitoring the PDCCH, according to the search space sets with group index 1, on the serving cell at a first slot that is at least P_{switch} symbols after the last symbol of the PDCCH with the DCI format 2_0; or
if the UE detects a DCI format 2_0 and a value of the search space set group switching flag field in the DCI format 2_0 is 1, the UE may start monitoring the PDCCH, according to search space sets with group index 1, and stop monitoring the PDCCH, according to search space sets with group index 0, on the serving cell at a first slot that is at least P_{switch} symbols after the last symbol of the PDCCH with the DCI format 2_0, and the UE may set the timer value to the value provided by the searchSpaceSwitching Timer-r16; or
if the UE monitors PDCCH on a serving cell, according to the search space sets with group index 1, the UE may start monitoring the PDCCH, on the serving cell according to search space sets with group index 0, and may stop monitoring the PDCCH, according to search space sets with group index 1, on the serving cell at the beginning of the first slot that is at least P_{switch} symbols after a slot where the timer expires or after the last symbol of a remaining channel occupancy duration for the serving cell that is indicated by a DCI format 2_0.

If a UE is not provided, by the SearchSpaceSwitchTrigger-r16, with a serving cell:
if the UE detects a DCI format by monitoring the PDCCH, according to a search space set with group index 0, the UE may start monitoring the PDCCH according to search space sets with group index 1, and stop monitoring the PDCCH according to search space sets with group index 0, on the serving cell at a first slot that is at least P_{switch} symbols after the last symbol of the PDCCH with the DCI format, the UE may set the timer value to the value provided by the searchSpaceSwitchingTimer-r16 if the UE detects a DCI format by monitoring the PDCCH in any search space set; or
if the UE monitors PDCCH on a serving cell according to search space sets with group index 1, the UE may start monitoring the PDCCH on the serving cell according to search space sets with group index 0, and stop monitoring the PDCCH according to search space sets with group index 1, on the serving cell at the beginning of the first slot that is at least P_{switch} symbols after a slot where the timer expires or, if the UE is provided a search space set to monitor a PDCCH for detecting a DCI format 2_0, after the last symbol of a remaining channel occupancy duration for the serving cell that is indicated by the DCI format 2_0.

The UE may determine a slot and a symbol in the slot to start or stop the PDCCH monitoring according to search space sets for a serving cell that the UE is provided by the searchSpaceGroupIdList-r16 or, if the searchSpaceSwitchingGroupList-r16 is provided, for a set of serving cells, based on the smallest SCS configuration μ among all the configured DL BWPs in the serving cell or in the set of serving cells and, if any, in the serving cell where the UE may receive a PDCCH and detect a corresponding DCI format 2_0 triggering the start or stop of the PDCCH monitoring, according to search space sets.

### Implicit SS Switching

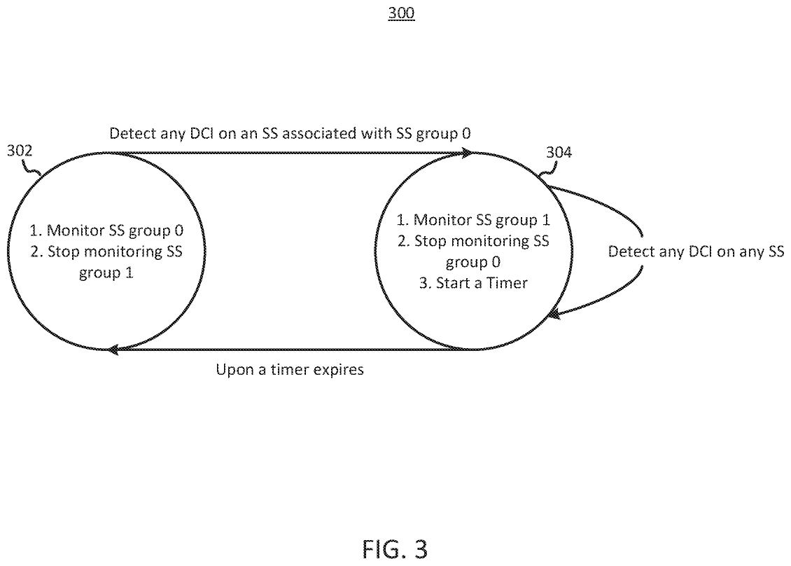

FIG. 3 is a state transition diagram 300 illustrating an implicit SS switching mechanism for a UE, according to an example implementation of the present disclosure. Implicit SS switching may be achieved when the UE is not configured with an RRC parameter searchSpaceSwitchTrigger-r16. In some implementations, implicit switching may be achieved via DCI (e.g., the DCI may be, but is not limited to, a DCI format 2_0) and/or a timer.

As illustrated in FIG. 3, when the UE is in the state 302, the UE monitors SS set group #0 and stops monitoring SS set group #1. When any DCI on an SS associated with SS set group #0 is detected by the UE, the UE may switch from the state 302 to the state 304.

When the UE is in the state 304, the UE monitors SS set group #1 and stops monitoring SS set group #0. In some implementations, the UE may start a timer in the state 304, and upon expiration of the timer, the UE may switch from the state 304 to the state 302. In some implementations, the UE may not switch to the state 302 even after detecting any DCI on any SS while the timer is running. The UE may switch to the state 302 only after the timer expires.

### Timer-Based SS Switching

In some implementations, a timer (e.g., searchSpaceSwitchingTimer) may be configured for the SS switching. For example, the UE may (re-)start the timer when: the DCI format 2_0 is detected by the UE and the SSSG switching flag is set to 1, any DCI on an SS associated with SS set group #0 is detected by the UE, or any DCI on any SS is detected by the UE. Upon expiration of the timer, the UE may switch the current SS to SS set group #0 (e.g., to monitor SS set group #0 and stop monitoring SS set group #1). The timer-based SS switching may be applied to both explicit SS switching and implicit SS switching, as illustrated in FIG. 2 and FIG. 3.

### Search Space Configuration Parameters

In some implementations, SS configuration parameters, such as monitoringSlotPeriodicityAndOffset and or duration in an SS Information Element (IE) (e.g., SearchSpace), may determine the specific slot(s) in the PDCCH that a UE monitors. In some implementations, parameters, such as monitoringSymbolsWithinSlot in the SS IE (e.g., SearchSpace) and duration in ControlResourceSet IE, may determine at least a PDCCH monitoring occasion pattern within a slot.

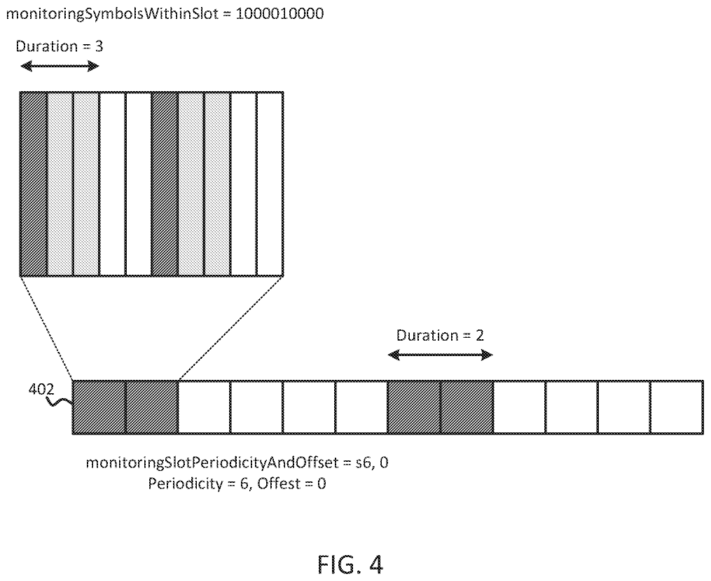

FIG. 4 is a schematic diagram 400 illustrating the identification of PDCCH monitoring occasions, according to an example implementation of the present disclosure. In some implementations, the parameter monitoringSymbolsWithinSlot may have a value of “1000010000” and a duration with a value of “3” in a slot 402. In some implementations, the parameter monitoringSlotPeriodicityAndOffset may have a value of (6, 0), indicating a periodicity of “6” and an offset of “0” with a duration with a value of “2”.

PDCCH Monitoring Indication and Dormancy/Non-Dormancy Behavior for sCells

A UE configured with a DRX mode operation may be provided with the following for the detection of a DCI format 2_6 in a PDCCH reception on the PCell or on the SpCell:
a PS-RNTI for a DCI format 2_6 by ps-RNTI;
a number of search space sets, by dci-Format2-6, to monitor a PDCCH for the detection of a DCI format 2_6 on the active DL BWP of the PCell or of the SpCell according to a common search space;
a payload size for a DCI format 2_6 by sizeDCI_2-6;
a location in a DCI format 2_6 of a Wake-up indication bit by psPositionDCI-2-6;
a ‘0’ value for the Wake-up indication bit, when reported to higher layers, indicates not to start the drx-onDurationTimer for the next long DRX cycle;
‘1’ value for the Wake-up indication bit, when reported to higher layers, indicates to start the drx-onDurationTimer for the next long DRX cycle;
a bitmap, when the UE is provided with a number of groups of configured SCells by Scell-groups-for-dormancy-outside-active-time, where the bitmap location is immediately after the Wake-up indication bit location, the bitmap size is equal to the number of groups of configured SCells where each bit of the bitmap corresponds to a group of configured SCells from the number of groups of configured SCells, a ‘0’ value for a bit of the bitmap indicates an active DL BWP, provided by dormant-BWP, for the UE for each activated SCell in the corresponding group of configured SCells, and a ‘1’ value for a bit of the bitmap indicates an active DL BWP and a current active DL BWP. The active DL BWP may be provided, by first-non-dormant-BWP-ID-for-DCI-outside-active-time, to the UE for each activated SCell, in the corresponding group of configured SCells, if a current active DL BWP is the dormant DL BWP. The current active DL BWP may be provided to the UE for each activated SCell, in the corresponding group of configured SCells, if the current active DL BWP is not the dormant DL BWP;
an offset by ps-Offset indicating a time, at which, the UE starts monitoring the PDCCH for the detection of a DCI format 2_6, according to the number of search space sets, prior to a slot, at which, the drx-onDuarationTimer may start on the PCell or on the SpCell, where, for each search space set, the PDCCH monitoring occasions may be the ones in the first Tₛ slots indicated by duration, or Tₛ=1 slot if duration is not provided, starting from the first slot of the first Tₛ slots and ending prior to the start of drx-onDurationTimer.

On the PDCCH monitoring occasions associated with the same long DRX Cycle, a UE is not expected to detect more than one DCI format 2_6 with different values of the Wake-up indication bit for the UE or with different values of the bitmap for the UE.

The UE may not monitor a PDCCH for detecting a DCI format 2_6 during Active Time.

If the UE reports for an active DL BWP a requirement of X slots prior to the beginning of a slot where the UE may start the drx-onDurationTimer, the UE may not be required to monitor a PDCCH for the detection of a DCI format 2_6 during the X slots, where X corresponds to the requirement of the SCS of the active DL BWP in Table 5 below.

TABLE 5
Minimum time gap value X

Minimum Time Gap X (slots)

| SCS (kHz) | Value 1 | Value 2 |
|---|---|---|
| 15 | 1 | 3 |
| 30 | 1 | 6 |
| 60 | 1 | 12 |
| 120 | 2 | 24 |

If the UE is provided with the search space sets to monitor a PDCCH for the detection of a DCI format 2_6 in the active DL BWP of the PCell or of the SpCell, and the UE detects a DCI format 2_6, the physical layer of a UE reports the value of the Wake-up indication bit for the UE to the higher layers for the next long DRX cycle.

If the UE is provided with the search space sets to monitor a PDCCH for the detection of a DCI format 2_6 in the active DL BWP of the PCell, or of the SpCell, and the UE does not detect a DCI format 2_6, the physical layer of the UE does not report a value of the Wake-up indication bit to the higher layers for the next long DRX cycle.

If the UE is provided with the search search space sets to monitor a PDCCH for the detection of a DCI format 2_6 in the active DL BWP of the PCell or of the SpCell and the UE is not required to monitor a PDCCH for the detection of a DCI format 2_6 for all the corresponding PDCCH monitoring occasions outside the Active Time prior to a next long DRX cycle or does not have any PDCCH monitoring occasions for the detection of a DCI format 2_6 outside the Active Time of a next long DRX cycle, the physical layer of the UE may report a value of 1 for the wake-up indication bit to the higher layers for the next long DRX cycle.

If the UE is provided with the search search space sets to monitor a PDCCH for the detection of a DCI format 0_1 and a DCI format 1_1 and if one or both of the DCI format 0_1 and the DCI format 1_1 include a SCell dormancy indication field, the SCell dormancy indication field is a bitmap with size equal to a number of groups of configured SCells, provided by Scell-groups-for-dormancy-within-active-time, where each bit of the bitmap may correspond to a group of configured SCells from the number of groups of configured Scells. If the UE detects a DCI format 0_1 or a DCI format 1_1 that does not include a carrier indicator field, or detects a DCI format 0_1 or a DCI format 1_1 that includes a carrier indicator field with a value equal to 0, a ‘0’ value for a bit of the bitmap may indicate an active DL BWP, provided by dormant-BWP, for the UE for each activated SCell in the corresponding group of configured SCells, and a ‘1’ value for a bit of the bitmap may indicate:
an active DL BWP, provided by first-non-dormant-BWP-ID-for-DCI-inside-active-time, for the UE for each activated SCell in the corresponding group of configured SCells, if a current active DL BWP is the dormant DL BWP, and
a current active DL BWP, for the UE for each activated SCell in the corresponding group of configured SCells, if the current active DL BWP is not the dormant DL BWP.

The UE may set the active DL BWP to the indicated active DL BWP.

If the UE is provided search space sets to monitor a PDCCH for the detection of a DCI format 1_1, and if
the CRC of a DCI format 1_1 is scrambled by a C-RNTI or a MCS-C-RNTI, and if
a one-shot HARQ-ACK request field is not present or has a ‘0’ value, and if
the UE detects a DCI format 1_1 on the primary cell that does not include a carrier indicator field, or detects a DCI format 1_1 on the primary cell that includes a carrier indicator field with a value equal to 0, and if
resourceAllocation=resourceAllocationType0 and all bits of the frequency domain resource assignment field in a DCI format 1_1 are equal to 0, or
resourceAllocation=resourceAllocationType1 and all bits of the frequency domain resource assignment field in a DCI format 1_1 are equal to 1, or
resourceAllocation=dynamicSwitch and all bits of the frequency domain resource assignment field in the DCI format 1_1 are equal to 0 or 1,

the UE may consider the DCI format 1_1 as indicating SCell dormancy, not scheduling a PDSCH reception or indicating an SPS PDSCH release, and for transport block 1 interprets the sequence of fields of
modulation and coding scheme,
new data indicator,
redundancy version,

and of
HARQ process number,
antenna port(s),
DMRS sequence initialization,

as providing a bitmap to each configured SCell, in an ascending order of the SCell index, where
a ‘0’ value for a bit of the bitmap indicates an active DL BWP, provided by dormant-BWP, for the UE for a corresponding activated SCell,
a ‘1’ value for a bit of the bitmap indicates:
an active DL BWP, provided by first-non-dormant-BWP-ID-for-DCI-inside-active-time, for the UE for a corresponding activated SCell, if a current active DL BWP is the dormant DL BWP, and
a current active DL BWP, for the UE for a corresponding activated SCell, if the current active DL BWP is not the dormant DL BWP.

The UE may set the active DL BWP to the indicated active DL BWP.

If an active DL BWP provided by dormant-BWP for a UE on an activated SCell is not a default DL BWP for the UE on the activated SCell, the BWP inactivity timer is not used for transitioning from the active DL BWP provided by dormant-BWP to the default DL BWP on the activated SCell.

A UE is expected to provide HARQ-ACK information in response to a detection of a DCI format 1_1 indicating SCell dormancy after N symbols from the last symbol of a PDCCH providing the DCI format 1_1. If processingType2Enabled of PDSCH-ServingCellConfig is set to enable for the serving cell with the PDCCH providing the DCI format 1_1, N=5 for μ=0, N=5.5 for μ=1, and N=11 for μ=2; otherwise, N=10 for μ=0, N=12 for μ=1, N=22for μ=2, and N=25 for μ=3, where μ is the smallest SCS configuration between the SCS configuration of the PDCCH providing the DCI format 1_1 and the SCS configuration of a PUCCH with the HARQ-ACK information in response to the detection of the DCI format 1_1.

### Skipping Monitoring a PDCCH (or “PDCCH Skipping”)

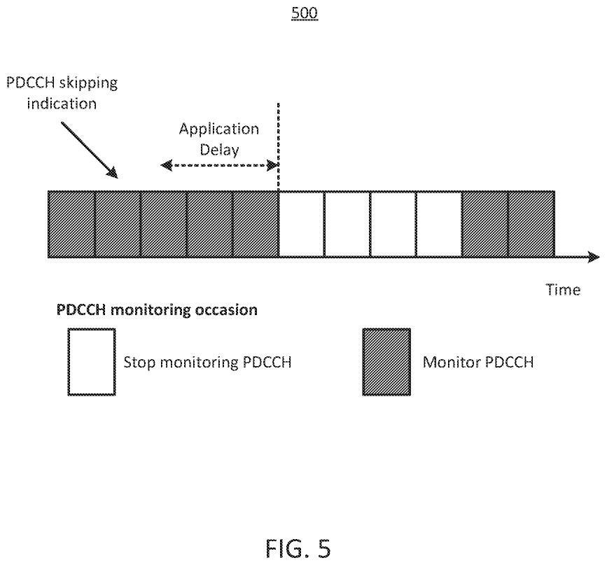

FIG. 5 is a schematic diagram 500 illustrating a scheme of skipping the PDCCH monitoring (or “PDCCH skipping scheme”), according to an example implementation of the present disclosure. In some implementations, the UE may receive DCI (containing/carrying a specific DCI format) that includes PDCCH skipping indication from the NW. The PDCCH skipping indication may be used to indicate to the UE information related to the PDCCH skipping scheme, such as a duration that the UE should skip/stop monitoring the PDCCH. The UE may start to apply the PDCCH skipping indication after a time period of application delay. After the duration within which the UE stops monitoring the PDCCH, the UE may restart monitoring the PDCCH (e.g., if the UE is operating in the DRX Active time). As illustrated in FIG. 5, the duration within which the UE stops monitoring the PDCCH may occupy four slots (e.g., the four rectangles without shading in FIG. 5). In some implementations, the length of the duration within which the UE stops monitoring the PDCCH may vary depending on the PDCCH skipping indication. In the present disclosure, “skipping the PDCCH monitoring” (or “PDCCH skipping”) may refer to not performing the PDCCH monitoring, forgoing the PDCCH monitoring, disabling the PDCCH monitoring, stopping performing the PDCCH monitoring, etc.

In some implementations, the NW may preconfigure one or more durations for the PDCCH sipping via one or more higher layer parameters (e.g., the RRC configuration). The PDCCH skipping indication may indicate which one of the configured durations should be applied for PDCCH skipping. For example, if the NW configures the UE with multiple durations for PDCCH skipping (e.g., including Duration #1 and Duration #2) via RRC signaling, the UE may know which one of the configured durations should be applied for PDCCH skipping (e.g., Duration #1 or Duration #2) according to the PDCCH skipping indication.

In some implementations, physical layer signaling may be used to further control PDCCH monitoring behaviors for a DRX on-duration based on a configured DRX mechanism. As such, the NW may send a physical layer signaling to a UE to determine whether or not the UE may wake up within a DRX on-duration (e.g., to start a drx-onDurationTimer for the next DRX cycle or not to start the drx-onDurationTimer for the next DRX cycle). The physical layer signaling may be called DCP, or DCI with CRC scrambled by PS-RNTI.

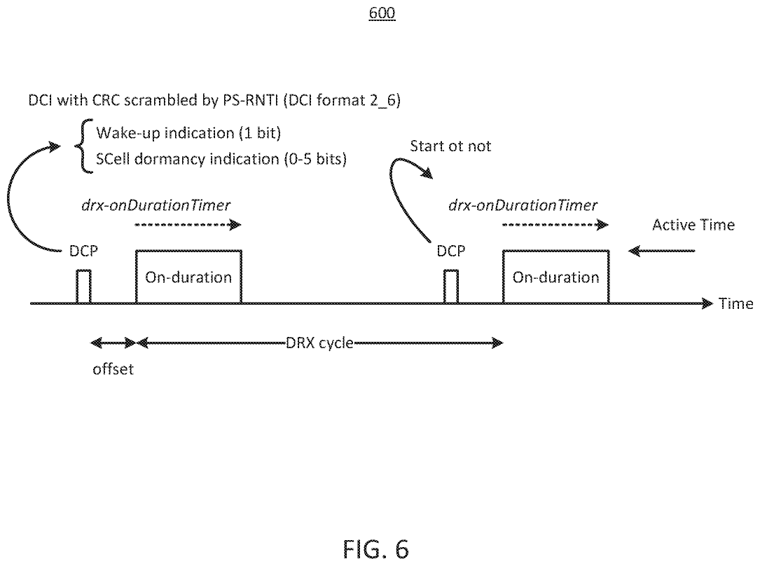

FIG. 6 is a schematic diagram 600 illustrating a DCP mechanism, according to an example implementation of the present disclosure. In some implementations, the DCP mechanism in FIG. 6 may be a DCP operation with a wake-up indication. In some implementations, a DCP may be indicated by a DCI format 2_6, which may be used for notifying power saving information outside a DRX Active Time for one or more UEs. In some implementations, the DCI format 2_6 may include a “wake-up indication” (e.g., represented by 1 bit) and a “dormancy indication” (e.g., SCell dormancy indication, which may be represented by 0-5 bits). The “wake-up indication” may be used to control PDCCH monitoring behaviors for an on-duration of a DRX via an on-duration timer (e.g., drx-onDurationTimer), and the “dormancy indication” may be used to control a BWP switching (e.g., entering or leaving a dormant BWP) for the serving cell(s) corresponding to a dormancy group.

In some implementations, with regards to BWP switching for serving cell(s) of a dormancy group, the NW may group one or more serving cells (e.g., SCells) into a dormancy group and may configure one or more dormancy groups. A dormancy group configuration may be indicated by at least one of the dormancyGroupWithinActiveTime IE and dormancyGroupOutsideActiveTime IE (in ServingCellConfig). The IE dormancyGroupWithinActiveTime or dormancyGroupOutsideActiveTime may contain an identification (ID) of a dormancy group within or outside an active time to which the serving cell may belong. In some implementations, an IE maxNrofDormancyGroups may determine the number of groups configured for a Cell Group. In some implementations, when a dormancy group(s) is configured, the NW may switch the BWPs for all the serving cells in the dormancy group(s) entering or leaving a dormant BWP via specific signaling (e.g., a DCI format 2_6, a DCI format 0_1, a DCI format 1_1, etc.).

### PDCCH Monitoring Adaptation

In some implementations, an indication (e.g., a 2-bit indication) in the self-scheduling DCI (e.g., a DCI format 1-1/0-1/1-2/0-2) may be used for triggering a procedure of the PDCCH monitoring adaptation in a single cell, in multiple cells, or in a group/set of cells. In some implementations, the indication may be the PDCCH indication of the monitoring adaptation. In some implementations, the PDCCH indication of monitoring adaptation may include at least one of the PDCCH skipping indication or the SSSG switching indication.

In some implementations, the bit size of the indication may be configurable. In some implementations, each bit of the indication may be mapped to a respective PDCCH monitoring behavior.

In some implementations, after receiving the PDCCH indication of the monitoring adaptation, the UE may adopt at least one of the following UE behaviors (1)-(5):
(1) not activating the PDCCH skipping scheme;
(2) stopping the PDCCH monitoring for a specific time duration;
(3) stopping monitoring the SS sets associated with SSSG #1 and SSSG #2 and monitoring of the SS sets associated with SSSG #0;
(4) stopping monitoring the SS sets associated with SSSG #0 and SSSG #2 and monitoring of the SS sets associated with SSSG #1; and
(5) stopping monitoring the SS sets associated with SSSG #0 and SSSG #1 and monitoring of the SS sets associated with SSSG #2.

In some implementations, after being indicated to skip the PDCCH monitoring and/or to switch to a ‘dormant’/‘empty’ SSSG, the UE may still perform the PDCCH monitoring (e.g., for HARQ retransmission) at least during a retransmission period. For example, the UE may switch from the current SSSG to another SSSG (e.g., a default SSSG or an SSSG specially configured only for the retransmission period) to perform the PDCCH monitoring. Additionally or alternatively, the UE may suspend or stop performing the PDCCH skipping scheme. Additionally or alternatively, the UE may perform the PDCCH monitoring discontinuously, according to the roundtrip and retransmission timers to receive the HARQ retransmission(s).

In some implementations, when triggered by DL DCI, the start and/or the end of a retransmission period may be determined when a HARQ-ACK condition is satisfied. For example, the HARQ-ACK condition may include the UE transmitting a NACK. The retransmission period may begin when the UE transmits a NACK.

In some implementations, the retransmission period may begin when a DRX retransmission timer (e.g., drx-RetransmissionTimerDL(UL)) starts and may end when the drx-RetransmissionTimerDL(UL) expires, if the UE is configured with DRX.

In some implementations, the retransmission period may begin when a HARQ RTT timer (e.g., drx-HARQ-RTT-TimerDL(UL)) starts and may end when the drx-RetransmissionTimerDL(UL) expires, if the UE is configured with DRX.

The PDCCH monitoring adaptation enables a UE to achieve the power saving effectively. PDCCH skipping and SSSG switching are two features considered to achieve the PDCCH monitoring adaptation. In some implementations, to reduce service latency for a retransmission, the PDCCH monitoring adaptation may take the interaction with data decoding and/or HARQ retransmission into consideration. For example, if a UE detects DCI indicating the PDCCH monitoring adaptation and the UE performs PDCCH skipping and/or SSSG switching (e.g., to a dormant/empty SSSG) right after an application delay) and the UE does not receive a PDSCH from the gNB or the gNB does not receive a PUSCH from the UE, the UE may not monitor the retransmission DCI immediately. The UE may start monitoring the retransmission DCI after a PDCCH skipping duration (e.g., the four slots within which the UE stops monitoring the PDCCH in FIG. 5), or after receiving another DCI for SSSG switching (e.g., out of dormant/empty SSSG), or after the (dormant/empty) SSSG timer expires which causes latency for retransmission. Therefore, after the UE performs the PDCCH monitoring adaptation (e.g., skipping the PDCCH monitoring for a duration and/or switching to a dormant/empty SSSG), the service latency for retransmission may be reduced if the UE still performs the PDCCH monitoring for a HARQ retransmission (e.g., DL assignment for PDSCH retransmission and/or UL grant for PUSCH retransmission) at least during a retransmission period.

An empty SSSG may include an SSSG within which no SS set(s) is configured. The UE may not monitor a PDCCH if the UE is switched to the empty SSSG. A dormant SSSG may have one or more associated SS sets. The UE may monitor the PDCCH conditionally (e.g., depending on HARQ-ACK, RTT timer(s) and/or retransmission timer(s) (e.g., drx-RetransmissionTimerDL, drx-RetransmissionTimerUL, drx-HARQ-RTT-TimerDL, and/or drx-HARQ-RTT-TimerUL)). A default SSSG may include an SSSG (configured in RRC) to which the UE may switch when the UE receives an SSSG switching indication or when the SSSG switching timer expires. An SSSG may include one or more CSS sets and/or one or more USS sets. In some implementations, each CSS set (and/or USS set) may be provided with a search space set group index. The CSS sets (and/or USS sets) provided with the same search space set group index may be considered to belong to the same SSSG.

In a case that the UE receives DCI indicating the PDCCH monitoring adaptation (e.g., PDCCH skipping and/or SSSG switching) for multiple serving cells (e.g., for a group of cells), and there is a retransmission period within the PDCCH monitoring adaptation duration/period, the UE may determine whether to perform the PDCCH monitoring adaptation (e.g., skipping the PDCCH monitoring for a duration and/or switching to dormant/empty SSSG) or perform the PDCCH monitoring for HARQ retransmission (e.g., DL assignment for PDSCH retransmission and/or UL grant for PUSCH retransmission) at least during a retransmission period for each serving cell indicated by the DCI for the PDCCH monitoring adaption in the multiple serving cells (e.g., in the group of cells).

In some implementations, the multiple serving cells (e.g., the group of cells) may include at least one of an SpCell (e.g., a PCell or a PSCell) and one or more SCells. In some implementations, the multiple serving cells (e.g., the group of cells) may include one or more SpCells and one or more SCells, where at least one of the one or more SCells may be associated with an SpCell and the at least one SCell and the associated SpCell may form a cell group.

In some implementations, the multiple serving cells (e.g., the group of cells) may include only the SCell(s) and does not include any SpCell. The SCell(s) may be associated with the same SpCell or associated with different SpCells.

In some implementations, the UE may perform the PDCCH monitoring in an SpCell (e.g., a PCell or a PSCell) at least during a retransmission period.

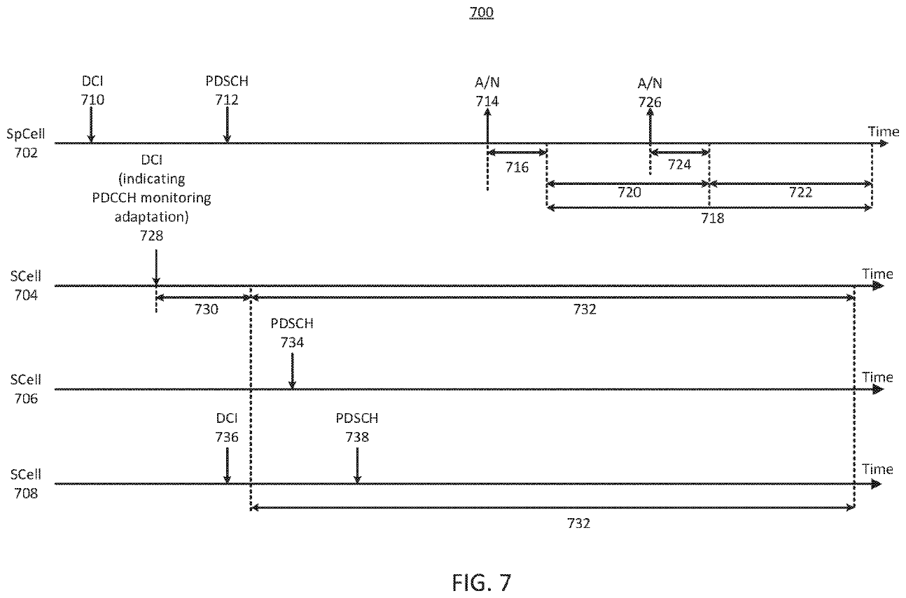

FIG. 7 is a timing diagram 700 illustrating that the UE performs the PDCCH monitoring in an SpCell 702 at least during a retransmission period, according to an example implementation of the present disclosure. In some implementations, after a UE receives (e.g., in SCell 704) DCI 728 indicating the PDCCH monitoring adaptation (e.g., for PDCCH skipping and/or SSSG switching) for multiple serving cells (e.g., for a set/group of cells including SCells 704 and 708), the UE may still perform the PDCCH monitoring (and/or default/normal/current SSSG switching) at least during a retransmission period 718 in the SpCell 702 and perform the PDCCH monitoring adaptation (e.g., skipping the PDCCH monitoring for a time duration 732 and/or switching to dormant/empty SSSG) in the multiple serving cells (e.g., SCells 704 and 708) other than the SpCell 702. In some implementations, the UE may change (e.g., skip, not apply, or disable) the PDCCH monitoring adaptation during the retransmission period (e.g., the retransmission period 718) to minimize the impact on data scheduling for new transmissions and retransmissions.

The notation “A/N” in FIG. 7 refers to a transmission of a HARQ ACK or a HARQ NACK.

For SCell 704 and SCell 708 indicated by the DCI 728 for the PDCCH monitoring adaptation, the UE may apply the PDCCH monitoring adaptation (e.g., within the time duration 732) after a PDCCH monitoring adaptation application delay 730. For example, within the time duration 732, the UE may skip monitoring the PDCCH on the SCell 704 and the SCell 708. In some implementations, the DCI 728 received on the SCell 704 may indicate cross-carrier scheduling that schedules a PDSCH 734 on another serving cell (e.g., SCell 706). In some implementations, the A/N for the PDSCH 734 may be contained/carried by the A/N 714.

In some implementations, the retransmission period 718 may be the time period within which one or more retransmission timers are running. For example, the UE may receive DCI 710 that schedules PDSCH 712 in SpCell 702 and transmit A/N 714 (e.g., a HARQ ACK or a HARQ NACK) that corresponds to PDSCH 712. Once the A/N 714 is transmitted, the UE may start a first drx-HARQ-RTT-TimerDL that is running during the time period 716. Once the first drx-HARQ-RTT-TimerDL expires (or the time period 716 ends), the UE may start a first drx-RetransmissionTimerDL that is running during the time period 720. In some implementations, the UE may transmit (on the SpCell 702) another A/N (e.g., A/N 726) for another serving cell (e.g., PDSCH 738). For example, the UE may transmit, on the SpCell 702, an A/N 726 that corresponds to the PDSCH 738 scheduled by the DCI 736 received in SCell 708. Once the A/N 726 is transmitted, the UE may start a second drx-HARQ-RTT-TimerDL that is running during the time period 724. Once the second drx-HARQ-RTT-TimerDL expires (or the time period 724 ends), the UE may start a second drx-RetransmissionTimerDL that is running during the time period 722. In this situation, the retransmission period 718 may be (or may include) the time period within which any of the configured retransmission timers (e.g., the first drx-HARQ-RTT-TimerDL and the second drx-HARQ-RTT-TimerDL) is running.

In some implementations, in a configuration of the set/group of cells for the PDCCH monitoring adaptation, the SpCell may not be included in any set/group of cells or the PDCCH adaptation monitoring. In some implementations, the DCI may implicitly or explicitly indicate whether the PDCCH monitoring adaptation for the SpCell may be applied when the set/group of cells including the SpCell is indicated to perform the PDCCH monitoring adaptation. An example of the implicit indication may be that the PDCCH monitoring adaptation for the SpCell is applied only if the DCI, received in the SpCell, indicates the PDCCH monitoring adaptation.

In some implementations, the UE may perform the PDCCH monitoring in all serving cell(s) at least during a retransmission period. For example, if the UE receives DCI indicating the PDCCH monitoring adaptation for multiple serving cells (e.g., for a set/group of cells), the UE may still perform the PDCCH monitoring (or default/normal/current SSSG switching) at least during the retransmission period in all the serving cells, regardless of whether the serving cells are indicated by the DCI. That is, the UE may not perform the PDCCH monitoring adaptation (e.g., for skipping the PDCCH monitoring for a duration and/or switching to a dormant/empty SSSG) at least during the retransmission periods in all the serving cells.

In some implementations, the UE may perform the PDCCH monitoring in all serving cell(s) indicated by the DCI for the PDCCH monitoring adaptation at least during a retransmission period. For example, if the UE receives DCI indicating the PDCCH monitoring adaptation (e.g., for PDCCH skipping and/or SSSG switching) for multiple serving cells (e.g., for a set/group of cells), the UE may still perform the PDCCH monitoring (or default/normal/current SSSG switching) at least during the retransmission period in the multiple serving cells (e.g., in the set/group of cells). That is, the UE may not perform the PDCCH monitoring adaptation (e.g., skipping the PDCCH monitoring for a duration and/or switching to dormant/empty SSSG) at least during the retransmission period in the multiple serving cells (e.g., in the set/group of cells).

In some implementations, the UE may perform the PDCCH monitoring at least during a retransmission period in all serving cell(s) indicated by the DCI for the PDCCH monitoring adaptation and the SpCell (e.g., PCell and/or PSCell).

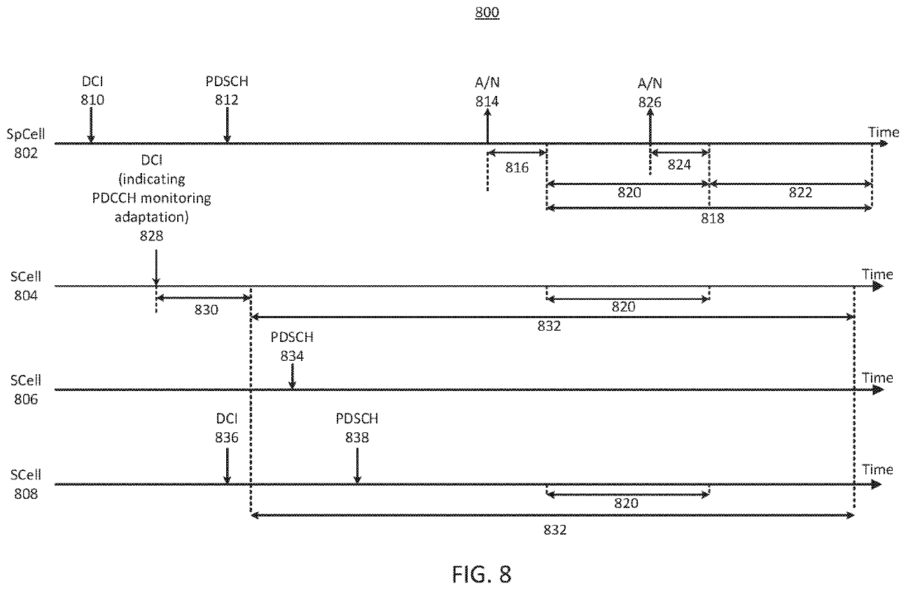

FIG. 8 is a timing diagram 800 illustrating that the UE performs the PDCCH monitoring at least during a retransmission period in the SpCell 802 and all serving cell(s) indicated by the DCI 828 for the PDCCH monitoring adaptation, according to an example implementation of the present disclosure. In some implementations, after the UE receives, on SCell 804, DCI 828 indicating the PDCCH monitoring adaptation (e.g., for PDCCH skipping and/or SSSG switching) for multiple serving cells (e.g., for a set/group of cells including SCells 804 and 808), the UE may still perform the PDCCH monitoring (or default/normal/current SSSG switching) at least during the retransmission period in the SpCell 802 and the multiple serving cells (e.g., the Scells 804 and 808) indicated by the DCI 828. In some implementations, the multiple serving cells (e.g., the group of cells) indicated by the DCI 828 for the PDCCH monitoring adaptation may only include SCell(s) (e.g., the SCells 804 and 808) and does not include any SpCell (e.g., SpCell 802). In some implementations, the UE may change (e.g., skip, not apply, or disable) the PDCCH monitoring adaptation during the retransmission period (e.g., the retransmission period 818) to minimize the impact on data scheduling for new transmissions and retransmissions.

The notation “A/N” in FIG. 8 refers to a transmission of a HARQ ACK or a HARQ NACK.

For the SCell 804 and the SCell 808 indicated by the DCI 828 for the PDCCH monitoring adaptation, the UE may apply the PDCCH monitoring adaptation within a time duration 832 after a PDCCH monitoring adaptation application delay 830. The UE may skip monitoring the PDCCH on the SCell 804 and the SCell 808 within the time duration 832, except for the time period 820 (within which a particular retransmission timer is running) or the retransmission period 818 (within which any of the configured retransmission timers is running). That is, the UE may still perform the PDCCH monitoring on the SCell 804 and the SCell 808 within the time period 820 or the retransmission period 818, even if the SCell 804 and the SCell 808 are indicated by the DCI 828 for the PDCCH monitoring adaptation.

In some implementations, the DCI 828 received on the SCell 804 may indicate cross-carrier scheduling that schedules a PDSCH 834 on another serving cell (e.g., SCell 806). In some implementations, the A/N for the PDSCH 834 may be contained/carried by the A/N 814.

In some implementations, the retransmission period 818 may be the time period within which one or more retransmission timers are running. For example, the UE may receive DCI 810 that schedules PDSCH 812 in SpCell 802 and transmit A/N (i.e., a HARQ ACK or a HARQ NACK) 814 that corresponds to PDSCH 812. Once the A/N 814 is transmitted, the UE may start a first drx-HARQ-RTT-TimerDL that is running during the time period 816. Once the first drx-HARQ-RTT-TimerDL expires (or the time period 816 ends), the UE may start a first drx-RetransmissionTimerDL that is running during the time period 820. In some implementations, the UE may transmit (on the SpCell 802) another A/N (e.g., A/N 826) for another serving cell (e.g., PDSCH 838). For example, the UE may transmit, on the SpCell 802, an A/N 826 that corresponds to the PDSCH 838 scheduled by the DCI 836 received in SCell 808. Once the A/N 826 is transmitted, the UE may start a second drx-HARQ-RTT-TimerDL that is running during the time period 824. Once the second drx-HARQ-RTT-TimerDL expires (or the time period 824 ends), the UE may start a second drx-RetransmissionTimerDL that is running during the time period 822. In this situation, the retransmission period 818 may be (or may include) the time period within which any of the retransmission timers (e.g., the first drx-HARQ-RTT-TimerDL and the second drx-HARQ-RTT-TimerDL) is running.

In some implementations, the UE may perform the PDCCH monitoring at least during a retransmission period in a specific cell, and the DCI indicating the PDCCH monitoring adaptation may be received from the specific cell.

In some implementations, if the UE receives, from a specific cell, DCI indicating the PDCCH monitoring adaptation (e.g., PDCCH skipping and/or SSSG switching) for multiple serving cells (e.g., for a set/group of cells), the UE may perform the PDCCH monitoring (or default/normal/current SSSG switching) at least during the retransmission period in the specific cell, and perform the PDCCH monitoring adaptation (such as skipping the PDCCH monitoring for a duration and/or switching to dormant/empty SSSG) in the multiple serving cells (e.g., in the set/group of cells) other than the specific cell. The specific cell may be a serving cell of the UE, such as an SpCell or an SCell.

In some implementations, the UE may perform the PDCCH monitoring at least during a retransmission period in a specific cell (on which the DCI indicating the PDCCH monitoring adaptation is received) and the SpCell (e.g., a Pcell or a PSCell).

In some implementations, if the UE receives, from a specific cell, DCI indicating the PDCCH monitoring adaptation (e.g., PDCCH skipping and/or SSSG switching) for multiple serving cells (e.g., for a group of cells), the UE may perform the PDCCH monitoring (or default/normal/current SSSG switching) at least during the retransmission period in the SpCell and the specific cell, and perform the PDCCH monitoring adaptation (e.g., skipping the PDCCH monitoring for a duration and/or switching to a dormant/empty SSSG) in the multiple serving cells (e.g., in the set/group of cells) other than both of the SpCell and the specific cell. The specific cell may be an SCell.

In some implementations, if the UE receives DCI indicating the PDCCH monitoring adaptation (e.g., skipping the PDCCH monitoring for a duration and/or switching to a dormant/empty SSSG) for a set/group of serving cells, the UE may perform the PDCCH monitoring (or default/normal/current SSSG switching) during a retransmission period in a first subset of serving cells in the set/group of serving cells and/or perform the PDCCH monitoring adaptation in a second subset of serving cells in the set/group of serving cells.

In some implementations, if a UE receives DCI indicating the PDCCH monitoring adaptation (e.g., skipping the PDCCH monitoring for a duration and/or switching to a dormant/empty SSSG) for a set/group of serving cells, the UE may perform the PDCCH monitoring during a retransmission period in a first subset of serving cells in the set/group of serving cells.

In some implementations, the first subset of serving cell(s) may include at least one of the following (1)-(5):
(1) an SpCell (e.g., PCell and/or PSCell),
(2) all serving cell(s) in the set/group of serving cells (which may be indicated by the DCI for the PDCCH monitoring adaptation),
(3) a serving cell that the UE receives/detects the DCI indicating the PDCCH monitoring adaptation from,
(4) all serving cell(s), e.g., including SpCell and/or SCell(s), or
(5) cell(s) configured by NW/RRC/IE. For example, the UE may be configured with a first subset of serving cell(s) by a specific IE. The first subset of serving cell(s) may include one or more serving cells in the set/group of serving cells and/or one or more serving cells not in the set/group of serving cells. In some implementations, the first subset of serving cell(s) may or may not include the SpCell.

In some implementations, the second subset of serving cell(s) may include at least one of the following (1)-(4):
(1) all serving cell(s) in the set/group of serving cells (indicated by the DCI for the PDCCH monitoring adaptation) other than the first subset of serving cell(s),
(2) all serving cell(s) in the set/group of serving cells (indicated by the DCI for the PDCCH monitoring adaptation) other than the SpCell (e.g., a PCell or a PSCell),
(3) all serving cell(s) in the set/group of serving cells (indicated by the DCI for the PDCCH monitoring adaptation) other than the serving cell that the UE receives/detects the DCI indicating the PDCCH monitoring adaptation from, or
(4) cell(s) configured by NW/RRC/IE. For example, the UE may be configured with a second subset of serving cell(s) by a specific IE. The second subset of serving cell(s) may include one or more serving cells in the set/group of serving cells and/or one or more serving cells not in the set/group of serving cells. In some implementations, the second subset of serving cell(s) may or may not include SpCell.

In some implementations, a retransmission period may begin at one of the following time points (1)-(6):
(1) at the last symbol of the DCI indicating the PDCCH monitoring adaptation,
(2) when/after the UE sets to NACK, or n slot(s) after the UE sets the NACK value in the HARQ-ACK codebook (for the DCI indicating the PDCCH monitoring adaptation is NACK),
(3) at/after the UE (re)starts the DL DRX HARQ RTT timer (e.g., drx-HARQ-RTT-TimerDL) or the DL DRX retransmission timer (e.g., drx-RetransmissionTimerDL), if DRX is configured,
(4) at/after the UE (re)starts the UL DRX HARQ RTT timer (e.g., drx-HARQ-RTT-TimerUL) or the UL DRX retransmission timer (e.g., drx-RetransmissionTimerUL) if DRX is configured,
(5) at/after the UE (re)starts drx-HARQ-RTT-TimerDL or drx-RetransmissionTimerDL and the UE sets the NACK value in the HARQ-ACK codebook (for the DCI indicating the PDCCH monitoring adaptation is NACK), and
(6) when the data of the corresponding HARQ process was not successfully decoded.

In some implementations, a retransmission period may end at one of the following time points (1)-(7):
(1) when/after the UE successfully completes (re)transmission (e.g., when/after the UE sends ACK for a retransmission DCI, sends ACK for a PDSCH transmission, receives a new transmission DCI for the same HARQ process of a previous PDSCH/PUSCH (re)transmission, and/or the UE determines that the data of the corresponding HARQ process was successfully decoded),
(2) when/after the UE transmits the HARQ-ACK corresponding to the DCI that indicates the PDCCH monitoring adaptation,
(3) when/after the UE transmits a PUSCH corresponding to the DCI that indicates the PDCCH monitoring adaptation and indicating the PUSCH transmission,
(4) when/after drx-RetransmissionTimerDL stops or expires if DRX is configured,
(5) when/after drx-RetransmissionTimerUL, stops or expires if DRX is configured, and/or
(6) when/after the UE receives a grant for UL retransmission, and
(7) when/after the UE receives a DL retransmission.

In some implementations, the UE behavior(s) of performing the PDCCH monitoring during a retransmission period may include at least one of the following (1)-(7):
(1) the UE starts the PDCCH monitoring on the SS set(s) configured in another SSSG (e.g., a default SSSG or an SSSG specially configured only for the retransmission period);
(2) the UE starts the PDCCH monitoring on the SS set(s) configured in another SSSG (e.g., a default SSSG or an SSSG specially configured only for the retransmission period) when the retransmission period begins;
(3) the UE suspends and/or stops the PDCCH monitoring on SS set(s) configured in the current SSSG (and/or in an empty SSSG, and/or in a dormant SSSG).
(4) the UE suspends and/or stops the PDCCH monitoring on SS set(s) configured in the current SSSG (and/or in empty SSSG, and/or in dormant SSSG) when the retransmission period starts;
(5) the UE starts the PDCCH monitoring;
(6) the UE suspends and/or stops PDCCH skipping adaptation; or
(7) the UE performs discontinuously the PDCCH monitoring according to the round trip (e.g., a (DL/UL) DRX HARQ RTT timer) and/or retransmission timers (e.g., a (DL/UL) DRX retransmission timer) to receive any scheduling for HARQ retransmissions.

In some implementations, the UE behavior(s) of performing the PDCCH monitoring adaptation (e.g., skipping the PDCCH monitoring for a duration and/or switching to dormant/empty SSSG) may include at least one of the following (1)-(5):
(1) the UE starts the PDCCH monitoring on the SS set(s) configured in the current SSSG (and/or in an empty SSSG, and/or in dormant SSSG) when the retransmission period begins;
(2) the UE suspends or stops the PDCCH monitoring on the SS set(s) configured in the current SSSG when the retransmission period begins;
(3) the UE starts the PDCCH monitoring on the SS set(s) configured in an SSSG (e.g., a default SSSG, an SSSG indicated by DCI, a configured SSSG, or a configured SSSG that is not an empty/dormant SSSG) when the retransmission period ends;
(4) the UE suspends or stops the PDCCH monitoring on the SS set(s) configured in the current SSSG (and/or in an empty SSSG and/or a dormant SSSG) when the retransmission period ends; or
(5) the UE stops the PDCCH monitoring for a configured/indicated duration/period.

In some implementations, the set/group of serving cells may include at least one of the following (1)-(4):
(1) a set/group of cells in a cell group configured by the NW and/or the higher layer (e.g., configured by the RRC layer via specific IEs, such as dormancyGroupWithinActiveTime, dormancyGroupOutsideActiveTime, and/or cellGroupsForSwitch) and indicated by DCI;
(2) multiple cell groups configured by the NW and/or the higher layer (e.g., configured by the RRC layer via specific IE(s) including dormancyGroupWithinActiveTime, dormancyGroupOutsideActiveTime, and/or cellGroupsForSwitch) and which one of the multiple cell groups is determined as the set/group of serving cells may be indicated by a DCI field. For example, the DCI field may be a bitmap and each bit of the bitmap may correspond to one of the multiple cell groups (e.g., a set/group of configured SCells);
(3) serving cells indicated by a sequence of DCI fields, where the sequence of DCI fields may be concatenated into a bitmap and each bit of the bitmap corresponds to a configured cell; or
(4) a cell group configured for the SCell dormancy, SSSG switching, PDCCH skipping, and/or the PDCCH monitoring adaptation.
   Stop PDCCH Skipping while RetransmissionTimerDL/UL is Running

In some implementations, when a UE receives DCI indicating the PDCCH monitoring adaptation (such as skipping the PDCCH monitoring for a duration and/or switching to dormant/empty SSSG) for a cell group configured by the RRC layer and/or indicated by the DCI in a first serving cell, the UE will perform the PDCCH monitoring adaptation for the serving cells in the cell group after a PDCCH monitoring adaptation application delay. The UE may stop/suspend the PDCCH monitoring adaptation (or PDCCH skipping) in the SpCell (e.g., PCell and/or PSCell), or in the serving cells in the cell group, or in the first serving cell during a window controlled by the higher layers. The length of the window (in msec) is provided by a parameter, such as the drx-HARQ-RTT-TimerDL/drx-HARQ-RTT-TimerUL/drx-RetransmissionTimerDL/drx-RetransmissionTimerUL.

Stop SSSG Switching while RetransmissionTimerDL/UL is Running

In some implementations, when/after the UE receives DCI indicating the PDCCH monitoring adaptation (e.g., skipping the PDCCH monitoring for a duration and/or switching to a dormant/empty SSSG) for a cell group configured by the RRC layer and/or indicated by the DCI in a first serving cell, the UE may perform the PDCCH monitoring adaptation for serving cells in the cell group after an (PDCCH monitoring adaptation) application delay. In some implementations, the UE may start the PDCCH monitoring in another SSSG and stop the PDCCH monitoring in the current SSSG in the SpCell, in the serving cells in the cell group, or in the first serving cell within a time window controlled by the higher layers. The length of the time window (in milliseconds or in other time units) may be determined by specific timer(s) including drx-HARQ-RTT-TimerDL, drx-HARQ-RTT-TimerUL, drx-RetransmissionTimerDL, and/or drx-RetransmissionTimerUL.

Stop PDCCH Skipping after NACK is Sent

In some implementations, when/after the UE receives DCI indicating the PDCCH monitoring adaptation (e.g., skipping the PDCCH monitoring for a duration and/or switching to a dormant/empty SSSG) for a cell group configured by the RRC layer and/or indicated by the DCI in a first serving cell, the UE may perform the PDCCH monitoring adaptation for serving cells in the cell group after an (PDCCH monitoring adaptation) application delay.

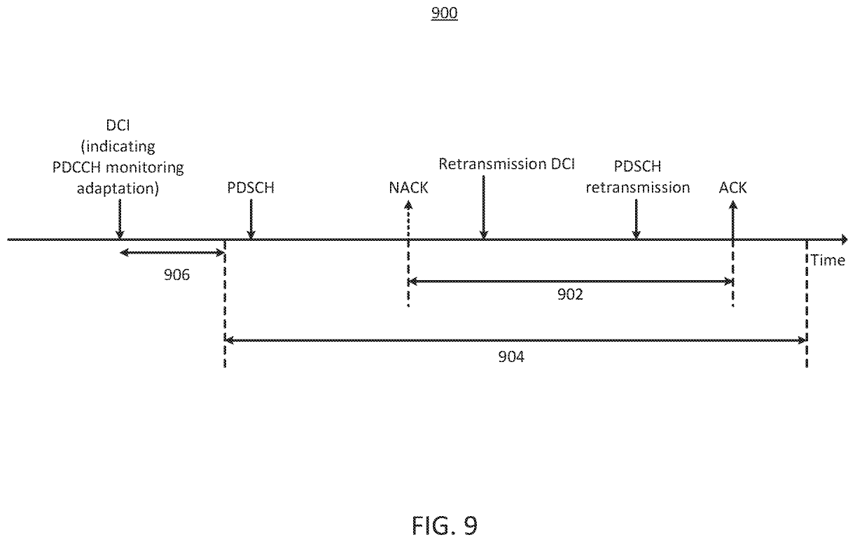

FIG. 9 is a schematic diagram 900 illustrating a retransmission period, according to an example implementation of the present disclosure. In some implementations, once the UE sets the NACK value in the HARQ-ACK codebook (e.g., and transmits the NACK to the NW), the UE may stop/suspend the PDCCH monitoring adaptation (or PDCCH skipping) until the UE successfully completes the retransmission (e.g., until the UE sends ACK for a retransmission DCI) in the SpCell (e.g., PCell and/or PSCell), or in the serving cells in the cell group, or in the first serving cell. As illustrated in FIG. 9, after receiving DCI indicating the PDCCH monitoring adaptation (e.g., for PDCCH skipping and/or SSSG switching), the UE may apply the PDCCH monitoring adaptation according to the DCI within a time duration 904 after a PDCCH monitoring adaptation application delay 906, except for a retransmission period 902 that may begin when the UE sets a NACK value in the HARQ-ACK codebook and end when the UE successfully completes the retransmission (e.g., when the UE sends an ACK for the retransmission DCI). That is, the UE may change/stop/suspend the PDCCH monitoring adaptation indicated by the DCI at least during the retransmission period 902.

In some implementations, the UE may stop/suspend the PDCCH monitoring adaptation (or PDCCH skipping) during a time window controlled by the higher layers (e.g., the RRC layer) when the UE sets a NACK value in the HARQ-ACK codebook in the SpCell, or in the serving cells in the cell group, or in the first serving cell. The length of the time window (in milliseconds or in other time units) may be provided by specific time(s), including drx-HARQ-RTT-TimerDL, drx-HARQ-RTT-TimerUL, drx-RetransmissionTimerDL, and/or drx-RetransmissionTimerUL.

In some implementations, in a case that the UE receives, in a first serving cell, DCI indicating the PDCCH monitoring adaptation (e.g., for skipping the PDCCH monitoring for a duration and/or switching to a dormant/empty SSSG) for a cell group configured by the RRC layer and/or indicated by the DCI, the UE may perform the PDCCH monitoring adaptation for serving cells in the cell group after an (PDCCH monitoring adaptation) application delay. In some implementations, the UE may stop/suspend the PDCCH monitoring adaptation (or PDCCH skipping) in response to sending a NACK to NW until the UE successfully completes the retransmission (e.g., until the UE sends an ACK for a retransmission DCI) in the SpCell (e.g., a PCell or a PSCell) or in the serving cells in the cell group, or in the first serving cell on which the DCI is received). In some implementations, the UE may stop/suspend the PDCCH monitoring adaptation (or PDCCH skipping) during a time window controlled by the higher layers (e.g., the RRC layer) when the UE sends a NACK in the SpCell, or in the serving cells in the cell group, or in the first serving cell. The length of the time window (e.g., in milliseconds or in other time units) may be determined by specific timer(s), including drx-HARQ-RTT-TimerDL, drx-HARQ-RTT-TimerUL, drx-RetransmissionTimerDL, and/or drx-RetransmissionTimerUL.

Stop SSSG Switching after NACK is Sent

In some implementations, when/after the UE receives DCI indicating the PDCCH monitoring adaptation (e.g., skipping the PDCCH monitoring for a duration and/or switching to a dormant/empty SSSG) for a cell group configured by the RRC layer and/or indicated by the DCI in a first serving cell, the UE may perform the PDCCH monitoring adaptation for the serving cells in the cell group after an (PDCCH monitoring adaptation) application delay. In some implementations, the UE may start the PDCCH monitoring in another SSSG and stop the PDCCH monitoring in the current SSSG when the UE sets a NACK value in the HARQ-ACK codebook until the UE successfully completes the retransmission (e.g., until the UE sends an ACK for retransmission DCI) in the SpCell (e.g., a PCell or a PSCell), or in the serving cells in the cell group, or in the first serving cell. In some implementations, the UE may start the PDCCH monitoring in another SSSG and stop the PDCCH monitoring in the current SSSG during a time window controlled by the higher layers (e.g., the RRC layer) when the UE sets a NACK value in the HARQ-ACK codebook in the SpCell, or in the serving cells in the cell group, or in the first serving cell. The length of the time window (e.g., in milliseconds or in other time units) may be determined by a specific timer(s), including drx-HARQ-RTT-TimerDL, drx-HARQ-RTT-TimerUL, drx-RetransmissionTimerDL, and/or drx-RetransmissionTimerUL.

### Start PDCCH Monitoring Adaptation Until ACK/PUSCH is Sent

In some implementations, when/after the UE receives DCI indicating the PDCCH monitoring adaptation (e.g., skipping the PDCCH monitoring for a duration and/or switching to a dormant/empty SSSG) for a cell group configured by the RRC layer and/or indicated by the DCI in a first serving cell, the UE may not perform the PDCCH monitoring adaptation for the serving cells in the cell group, or for the SpCell, or for the first serving cell, until the UE sets an ACK value in the HARQ-ACK codebook (or until the PUSCH is transmitted).

### Start SSSG Switching Adaptation Until ACK/PUSCH is Sent

In some implementations, when/after the UE receives DCI indicating the PDCCH monitoring adaptation (e.g., skipping the PDCCH monitoring for a duration and/or switching to a dormant/empty SSSG) for a cell group configured by the RRC layer and/or indicated by the DCI in a first serving cell, the UE may not start the PDCCH monitoring in another SSSG and stop the PDCCH monitoring in the current SSSG for the serving cells in the cell group, or for the SpCell, or for the first serving cell, until the UE sets an ACK value in the HARQ-ACK codebook (or until the PUSCH is transmitted).

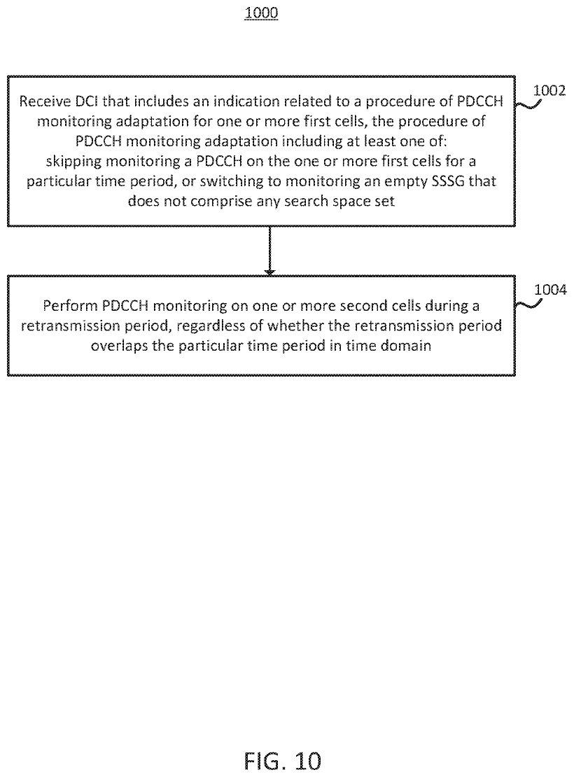

FIG. 10 is a flowchart of a method 1000 performed by a UE for power saving, according to an example implementation of the present disclosure. Although actions 1002 and 1004 are illustrated as separate actions represented as independent blocks in FIG. 10, these separately illustrated actions should not be construed as necessarily order-dependent. The order in which the actions are performed in FIG. 10 is not intended to be construed as a limitation, and any number of the disclosed blocks may be combined in any order to implement the method, or an alternate method. Moreover, each of actions 1002 and 1004 may be performed independently of other actions, and can be omitted in some implementations of the present disclosure.

In action 1002, the UE may receive DCI that includes an indication related to a procedure of a PDCCH monitoring adaptation for one or more first cells. The procedure of the PDCCH monitoring adaptation may include at least one of: skipping monitoring a PDCCH on the one or more first cells for a particular time period (or duration) or switching to monitoring an empty SSSG that does not include any search space set.

In some implementations, the DCI that includes an indication related to a procedure of the PDCCH monitoring adaptation (for one or more first cells) may refer to the DCI indicating the PDCCH monitoring adaptation as described in the present disclosure. The indication related to a procedure of the PDCCH monitoring adaptation may be a PDCCH indication of monitoring adaptation or a PDCCH skipping indication. The UE may perform the procedure of the PDCCH monitoring adaptation (or “PDCCH monitoring adaptation”) in response to receiving the DCI.

In action 1004, the UE may perform the PDCCH monitoring on one or more second cells during a retransmission period, regardless of whether the retransmission period overlaps the particular time period in time domain.

With method 1000, the UE is enabled to receive the retransmitted data from the NW during the retransmission period without being affected by the PDCCH adaptation, thereby ensuring the reliability of data transmission and at the same time meeting the power saving requirements. Furthermore, the UE is enabled to receive the retransmitted data from the NW during the retransmission period without waiting until a particular time period (e.g., the PDCCH skipping duration) ends, thereby shortening the retransmission latency. Furthermore, the UE is enabled to receive the retransmitted data before the particular time period (e.g., the PDCCH skipping duration) ends, thereby shortening the retransmission latency.

In some implementations, performing the PDCCH monitoring may further include terminating the procedure of the PDCCH monitoring adaptation. In some implementations, terminating the procedure of the PDCCH monitoring adaptation may cause the UE to keep monitoring the PDCCH at least during the retransmission period in the one or more first cells.

As described in the present disclosure, the beginning and the end of the retransmission period may be determined by various timer(s) and/or event(s). For example, the retransmission period may be a time period in which a DRX retransmission timer is running.

In some implementations, the DRX retransmission timer may be determined by a parameter denoted by drx-RetransmissionTimerDL. In some implementations, the DRX retransmission timer may be determined by a parameter denoted by drx-RetransmissionTimerUL.

In some implementations, the retransmission period may overlap at least a part of the particular time period (e.g., the duration within which the UE is indicated by the DCI to stop monitoring the PDCCH) in the time domain.

In some implementations, the one or more second cells may include at least one of a PCell, an SpCell, or an SCell.

In some implementations, the DCI may indicate the one or more first cells.

In some implementations, the one or more second cells may include at least one of the one or more first cells indicated by the DCI.

In some implementations, the one or more second cells may include a third cell where the UE receives the DCI.

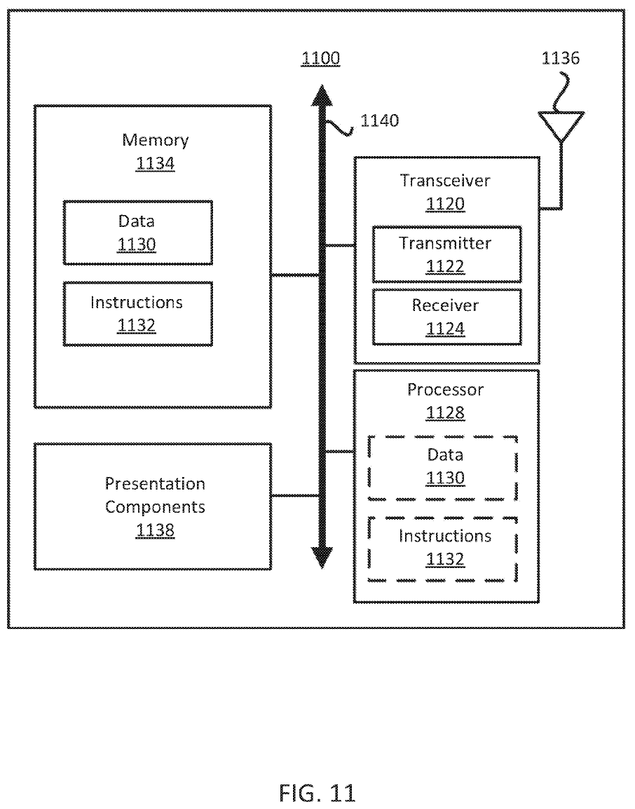

FIG. 11 is a block diagram illustrating a node 1100 for wireless communication, according to an example implementation of the present disclosure. As illustrated in FIG. 11, a node 1100 may include a transceiver 1120, a processor 1128, a memory 1134, one or more presentation components 1138, and at least one antenna 1136. The node 1100 may also include a radio frequency (RF) spectrum band module, a BS communications module, a network communications module, and a system communications management module, Input/Output (I/O) ports, I/O components, and a power supply (not illustrated in FIG. 11).

Each of the components may directly or indirectly communicate with each other over one or more buses 1140. The node 1100 may be a UE or a BS that performs various functions disclosed with reference to FIGS. 1 through 10.

The transceiver 1120 has a transmitter 1122 (e.g., transmitting/transmission circuitry) and a receiver 1124 (e.g., receiving/reception circuitry) and may be configured to transmit and/or receive time and/or frequency resource partitioning information. The transceiver 1120 may be configured to transmit in different types of subframes and slots including, but not limited to, usable, non-usable and flexibly usable subframes and slot formats. The transceiver 1120 may be configured to receive data and control channels.

The node 1100 may include a variety of computer-readable media. Computer-readable media may be any available media that may be accessed by the node 1100 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information, such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 1134 may include computer-storage media in the form of volatile and/or non-volatile memory. The memory 1134 may be removable, non-removable, or a combination thereof. Example memory may include solid-state memory, hard drives, optical-disc drives, etc. As illustrated in FIG. 11, the memory 1134 may store a computer-readable and/or computer-executable program 1132 (e.g., software codes or a set of instructions) that are configured to, when executed, cause the processor 1128 to perform various functions disclosed herein, for example, with reference to FIG. 1 through 10. Alternatively, the program 1132 may not be directly executable by the processor 1128 but may be configured to cause the node 1100 (e.g., when compiled and executed) to perform various functions disclosed herein.

The processor 1128 (e.g., having processing circuitry) may include an intelligent hardware device, e.g., a Central Processing Unit (CPU), a microcontroller, an ASIC, etc. The processor 1128 may include memory. The processor 1128 may process the data 1130 and the program 1132 received from the memory 1138, and information transmitted and received via the transceiver 1120, the baseband communications module, and/or the network communications module. The processor 1128 may also process information to send to the transceiver 1120 for transmission via the antenna 1136 to the network communications module for transmission to a Core Network (CN).

One or more presentation components 1138 may present data indications to a person or another device. Examples of presentation components 1138 may include a display device, a speaker, a printing component, a vibrating component, etc.

In view of the present disclosure, various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are considered in all respects as illustrative and not restrictive. It should also be understood that the present disclosure is not limited to the specific implementations disclosed. Still, many rearrangements, modifications, and substitutions are possible without departing from the scope of the present disclosure.

1. A method performed by a User Equipment (UE) for power saving, the method comprising:
receiving Downlink Control Information (DCI) comprising an indication related to a procedure of a Physical Downlink Control Channel (PDCCH) monitoring adaptation for one or more first cells, the procedure of the PDCCH monitoring adaptation comprising at least one of:
skipping monitoring a PDCCH on the one or more first cells for a particular time period, or
switching to monitoring an empty Search Space Set Group (SSSG) that does not comprise any search space set; and
performing a PDCCH monitoring on one or more second cells during a retransmission period, regardless of whether the retransmission period overlaps the particular time period in time domain.

2. The method of claim 1, wherein performing the PDCCH monitoring comprises:
terminating the procedure of the PDCCH monitoring adaptation.

3. The method of claim 1, wherein the retransmission period is a time period in which a Discontinuous Reception (DRX) retransmission timer is running.

4. The method of claim 3, wherein the DRX retransmission timer is determined by a parameter denoted by drx-RetransmissionTimerDL.

5. The method of claim 3, wherein the DRX retransmission timer is determined by a parameter denoted by drx-RetransmissionTimerUL.

6. The method of claim 1, wherein the retransmission period overlaps at least a part of the particular time period in the time domain.

7. The method of claim 1, where the one or more second cells comprise at least one of
a Primary Cell (PCell),
a Special Cell (SpCell), or
a Secondary Cell (SCell).

8. The method of claim 1, wherein the DCI indicates the one or more first cells.

9. The method of claim 8, wherein the one or more second cells comprise at least one of the one or more first cells indicated by the DCI.

10. The method of claim 1, wherein the one or more second cells comprise a cell through which the UE receives the DCI.

11. A User Equipment (UE) for power saving, the UE comprising:
at least one processor; and
at least one memory coupled to the at least one processor, the at least one memory storing a set of computer-executable instructions that, when executed by the at least one processor, cause the UE to:
receive Downlink Control Information (DCI) comprising an indication related to a procedure of a Physical Downlink Control Channel (PDCCH) monitoring adaptation for one or more first cells, the procedure of the PDCCH monitoring adaptation comprising at least one of:
skipping monitoring a PDCCH on the one or more first cells for a particular time period, or
switching to monitoring an empty Search Space Set Group (SSSG) that does not comprise any search space set; and
perform a PDCCH monitoring on one or more second cells during a retransmission period, regardless of whether the retransmission period overlaps the particular time period in time domain.

12. The UE of claim 11, wherein performing the PDCCH monitoring comprises:
terminating the procedure of the PDCCH monitoring adaptation.

13. The UE of claim 11, wherein the retransmission period is a time period in which a Discontinuous Reception (DRX) retransmission timer is running.

14. The UE of claim 13, wherein the DRX retransmission timer is determined by a parameter denoted by drx-RetransmissionTimerDL.

15. The UE of claim 13, wherein the DRX retransmission timer is determined by a parameter denoted by drx-RetransmissionTimerUL.

16. The UE of claim 11, wherein the retransmission period overlaps at least a part of the particular time period in the time domain.

17. The UE of claim 11, where the one or more second cells comprise at least one of
a Primary Cell (PCell),
a Special Cell (SpCell), or
a Secondary Cell (SCell).

18. The UE of claim 11, wherein the DCI indicates the one or more first cells.

19. The UE of claim 18, wherein the one or more second cells comprise at least one of the one or more first cells indicated by the DCI.

20. The UE of claim 11, wherein the one or more second cells comprise a cell through which the UE receives the DCI.
